(19) United States
(12) Patent Application Publication
(10) Pub. No.: US 2022/0183174 A1
(43) Pub. Date: Jun. 9, 2022

(54) ELECTRONIC DEVICE INCLUDING FLEXIBLE DISPLAY

(71) Applicant: Samsung Electronics Co., Ltd., Suwon-si (KR)

(72) Inventors: Jaehyun BAE, Suwon-si (KR); Changsu LEE, Suwon-si (KR); Kyunghoon LIM, Suwon-si (KR); Hyunsuk CHOI, Suwon-si (KR)

(21) Appl. No.: 17/545,934

(22) Filed: Dec. 8, 2021

Related U.S. Application Data
(63) Continuation of application No. PCT/KR2021/017311, filed on Nov. 23, 2021.

(30) Foreign Application Priority Data
Dec. 4, 2020 (KR) 10-2020-0168280

(51) Int. Cl. H05K 5/03; H05K 5/02; H05K 5/00

(52) U.S. Cl. CPC H05K 5/03; H05K 5/0017; H05K 5/0226

(57) ABSTRACT

According to various embodiments, an electronic device may include a first housing, a second housing foldably connected to the first housing through a hinge, and a flexible display having a first portion corresponding to the first housing, a second portion corresponding to the second housing, and a bendable third portion connecting the first portion and the second portion. The flexible display includes a window layer having a first region corresponding to the first portion, a second region corresponding to the second portion, and a third region corresponding to the bendable third portion and constituted to be bendable, a display panel disposed under the window layer, and a subsidiary material layer disposed under the display panel. The window layer includes a glass layer that has a plurality of openings formed in the third region and a filling member having a specified refractive index and filling the plurality of openings. The plurality of openings may be formed to have different opening ratios depending on a curvature of each bent region of the glass layer when the housing and the foldable display are in a folded state.

### CROSS-REFERENCE TO RELATED APPLICATIONS

This application is a continuation of International Application No. PCT/KR2021/017311 filed on Nov. 23, 2021, which claims priority to Korean Patent Application No. 10-2020-0168280 filed on Dec. 4, 2020, the disclosures of which are herein incorporated by reference in their entirety.

### BACKGROUND

### 1. Field

Various embodiments of the disclosure relate to an electronic device including a flexible display.

### 2. Description of Related Art

Electronic devices are gradually becoming slimmer, and are being improved to increase their rigidity, strengthen their design aspects, and differentiate their functional features. The electronic device is being developed to have various shapes, departing from a uniform rectangular shape. The electronic device may have a deformable structure that provides high portability and also provides a large-screen display in use. In connection with such a deformable structure, the electronic device may include a foldable electronic device including at least two foldable housings that are folded or unfolded relative to each other, a slidable electronic device including housings that slidingly move at a specified reciprocating distance relative to each other, or a rollable electronic device including at least one housing that is deformed in a rolling manner. Such electronic devices may include a flexible display that is bendable at least in part and corresponds to housings deformable in various ways, and the flexible display may require improved bendability.

### SUMMARY

The foldable electronic device may include a hinge, and first and second housings rotatably connected to the hinge in opposite directions, respectively. The foldable electronic device may be operated in an in-folding and/or out-folding scheme as the first housing is rotated with respect to the second housing through the hinge in a range of 0 to 360 degrees. The foldable electronic device may include the flexible display disposed to cross the first housing and the second housing in a 180-degree unfolded state. The flexible display is disposed in such a way that a display panel is stacked under a window layer made of a bendable polymer (e.g., polyimide) material, thereby providing bendability.

However, although the window layer made of a polymer material is capable of providing bendability, transmittance or scratch resistance may be poor. As a countermeasure against this, a thin glass layer (e.g., ultra-thin glass (UTG)) is provided in the window layer, but it may be difficult to ensure rigidity because the glass layer is formed as a thin film to provide bendability. Furthermore, when an electronic pen is applied to the electronic device, and a pen tip of the electronic pen presses the outer surface of the window layer with a certain pressing force, the flexible display having reinforced rigidity to withstand this may be required.

Various embodiments of the disclosure may provide an electronic device including a flexible display capable of ensuring at least in part bendability.

Various embodiments of the disclosure may provide a flexible display with enhanced transmittance and scratch resistance while ensuring rigidity.

According to various embodiments, an electronic device may include a first housing, a second housing foldably connected to the first housing through a hinge, and a flexible display having a first portion corresponding to the first housing, a second portion corresponding to the second housing, and a bendable third portion connecting the first portion and the second portion, the flexible display including a window layer having a first region corresponding to the first portion, a second region corresponding to the second portion, and a third region corresponding to the bendable third portion and constituted bend, a display panel disposed under the window layer, and a subsidiary material layer disposed under the display panel, wherein the window layer includes a glass layer that has a plurality of openings formed in the third region and a filling member having a specified refractive index and filling the plurality of openings, and wherein the plurality of openings are formed to have different opening ratios depending on a curvature of each bent region of the glass layer during bending.

According to various embodiments, an electronic device may include at least one bendable housing, and a flexible display including a bending portion that is bendable at least in part through a support of the at least one housing, the flexible display including a window layer, a display panel disposed under the window layer, and a subsidiary material layer disposed under the display panel, wherein the window layer includes a glass layer that has a plurality of openings formed in a region corresponding to the bending portion at specified intervals, and a filling member filling the plurality of openings, and wherein the plurality of openings are formed to have different opening ratios depending on a curvature of each bent region in the bending portion during bending.

In a flexible display according to embodiments of the disclosure, a window layer including a glass layer is provided in which a plurality of openings having different opening ratios for each region are formed to have different bendability in a bendable portion, and a filling member having substantially the same refractive index as the glass layer is filled in the plurality of openings. It is therefore possible to provide excellent bendability while ensuring rigidity.

In addition, various effects explicitly or implicitly appreciated through the disclosure may be provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a front perspective view illustrating a flat state or an unfolding state of an electronic device according to various embodiments of the disclosure.

FIG. 1B is a plan view illustrating a front surface of the electronic device in the unfolding state according to various embodiments of the disclosure.

FIG. 1C is a plan view illustrating a rear surface of the electronic device in the unfolding state according to various embodiments of the disclosure.

FIG. 2A is a perspective view illustrating a folding state of the electronic device according to various embodiments of the disclosure.

FIG. 2B is a perspective view illustrating an intermediate state of the electronic device according to various embodiments of the disclosure.

FIG. 3 is an exploded perspective view illustrating the electronic device according to various embodiments of the disclosure.

FIG. 4 is an exploded perspective view illustrating a flexible display according to various embodiments of the disclosure.

FIG. 5A is a plan view illustrating a window layer according to various embodiments of the disclosure.

FIG. 5B is an enlarged view illustrating a region 5b of FIG. 5A according to various embodiments of the disclosure.

FIG. 5C is a partial cross-sectional view of the window layer taken along a line 5c-5c of FIG. 5B according to various embodiments of the disclosure.

FIG. 6 is a partial cross-sectional view of a window layer having a plurality of openings determined depending on a pen tip of an electronic pen according to various embodiments of the disclosure.

FIG. 7 is a view illustrating a folding state of a flexible display according to various embodiments of the disclosure.

FIG. 8 is a view illustrating a manufacturing process of a flexible display according to various embodiments of the disclosure.

FIGS. 9A and 9B are partial plan views of a glass layer having a plurality of openings according to various embodiments of the disclosure.

FIGS. 10A and 10B are partial cross-sectional views of a flexible display including a glass layer with a plurality of recesses according to various embodiments of the disclosure.

FIG. 11A is a plan view of a window layer according to various embodiments of the disclosure.

FIG. 11B is an enlarged view illustrating a region 11b of FIG. 11A according to various embodiments of the disclosure.

FIG. 12A is a view illustrating an unfolding state of an electronic device according to various embodiments of the disclosure.

FIG. 12B is a view illustrating a folding state of an electronic device according to various embodiments of the disclosure.

FIG. 12C is a partial plan view of a glass layer having regions corresponding to first and second folding regions according to various embodiments of the disclosure.

FIGS. 13A and 13B are views illustrating the front and rear of an electronic device according to various embodiments of the disclosure.

FIG. 13C is a partial plan view of a glass layer having a region corresponding to a second portion according to various embodiments of the disclosure.

### DETAILED DESCRIPTION

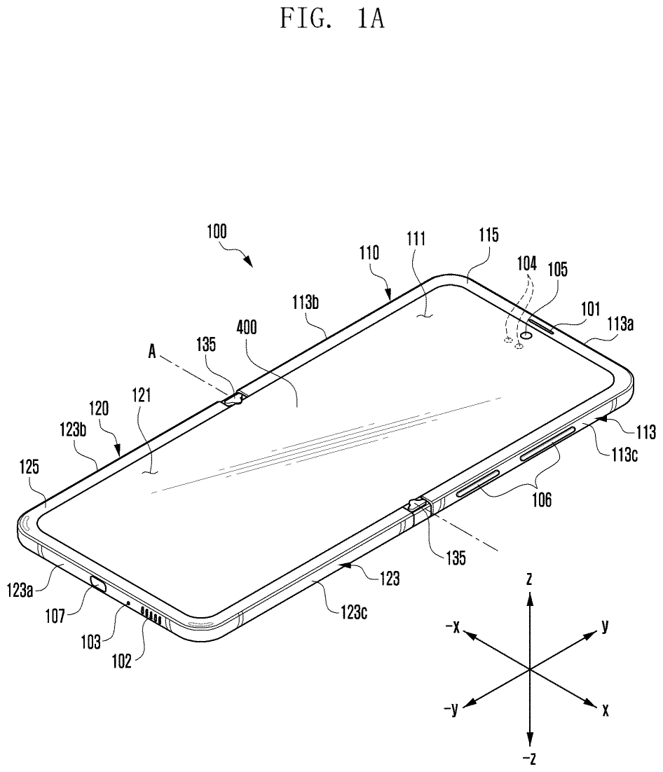

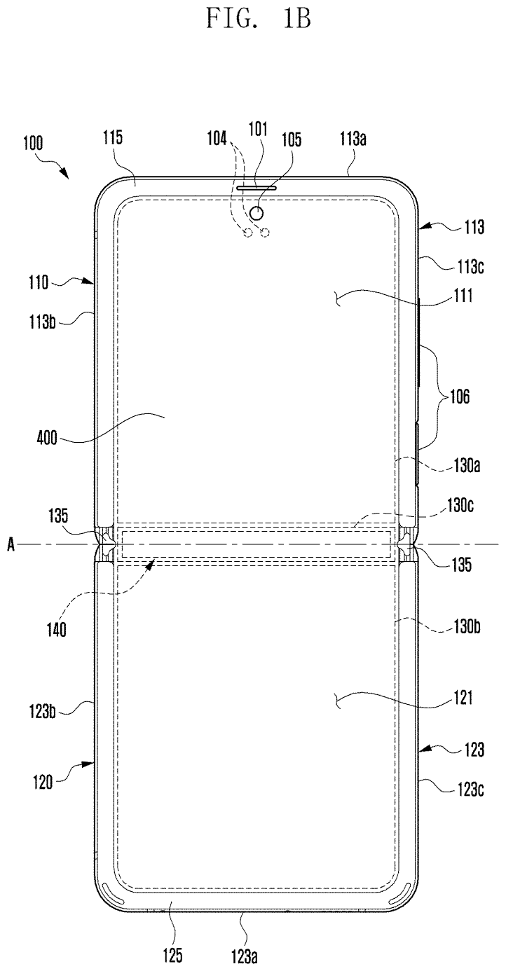

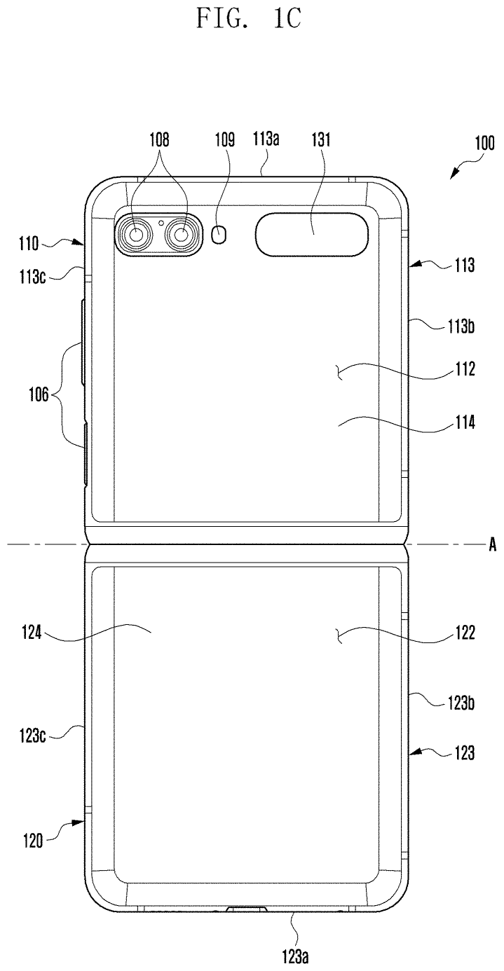

FIGS. 1A through 13C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1A is a front perspective view of an electronic device in a flat or unfolded state according to certain embodiments of the disclosure. FIG. 1B is a plan view illustrating the front of the electronic device in an unfolded state according to certain embodiments of the disclosure. FIG. 1C is a plan view illustrating the back of the electronic device in an unfolded state according to certain embodiments of the disclosure.

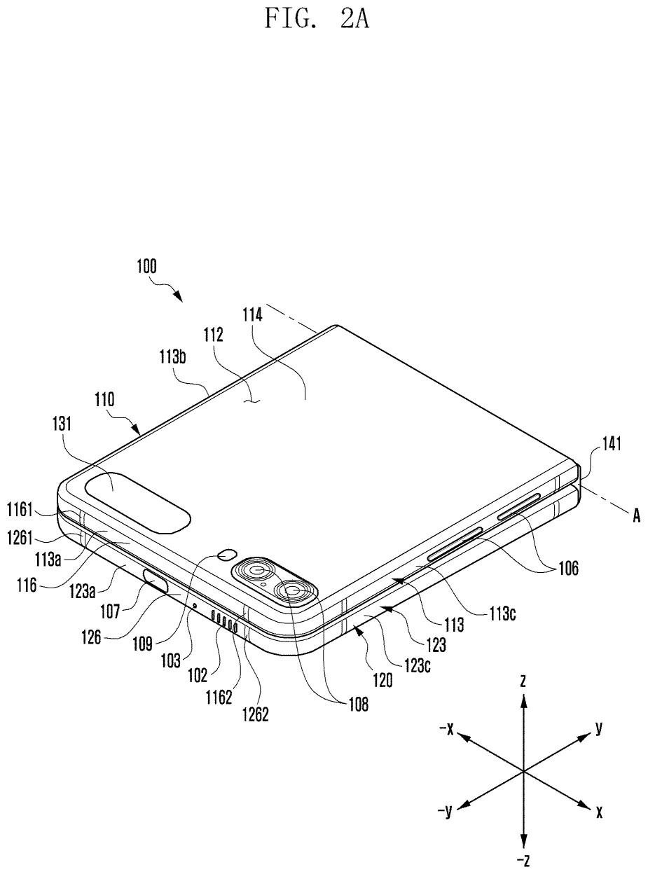

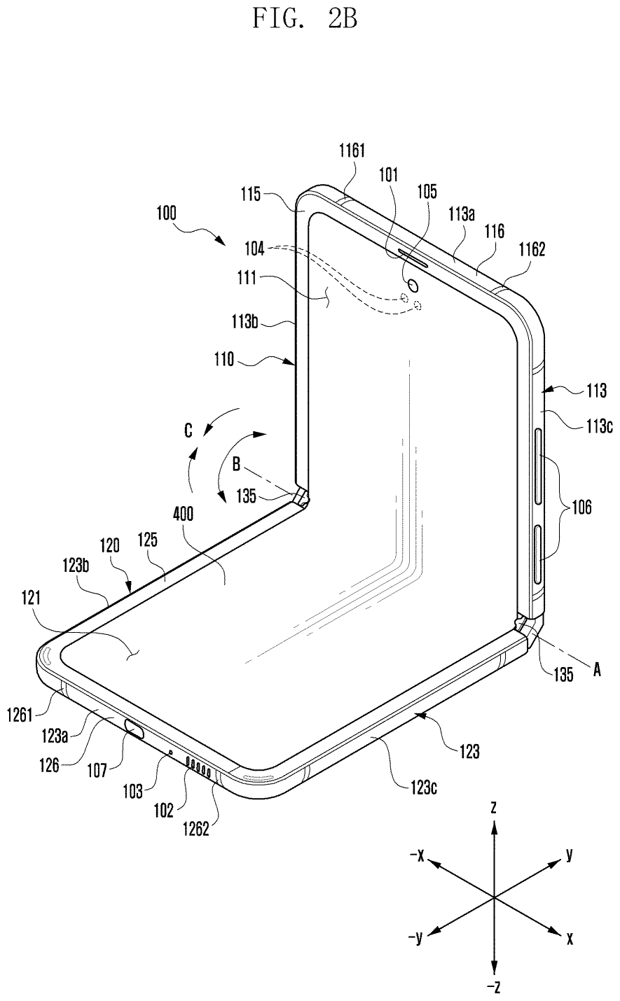

FIG. 2A is a perspective view of the electronic device in a folded state according to certain embodiments of the disclosure. FIG. 2B is a perspective view of the electronic device in an intermediate state according to certain embodiments of the disclosure.

With reference to FIGS. 1A to 2B, the electronic device 100 may include a pair of housings 110 and 120 (e.g., foldable housings) that are rotatably coupled as to allow folding relative to a hinge mechanism (e.g., hinge mechanism 140 in FIG. 1B). In certain embodiments, the hinge mechanism (e.g., hinge mechanism 140 in FIG. 1B) may be disposed in the X-axis direction or in the Y-axis direction. In certain embodiments, two or more hinge mechanisms (e.g., hinge mechanism 140 in FIG. 1B) may be arranged to be folded in a same direction or in different directions. According to an embodiment, the electronic device 100 may include a flexible display 400 (e.g., foldable display) disposed in an area formed by the pair of housings 110 and 120. According to an embodiment, the first housing 110 and the second housing 120 may be disposed on both sides about the folding axis (axis A), and may have a substantially symmetrical shape with respect to the folding axis (axis A). According to an embodiment, the angle or distance between the first housing 110 and the second housing 120 may vary, depending on whether the state of the electronic device 100 is a flat or unfolded state, a folded state, or an intermediate state.

According to certain embodiments, the pair of housings 110 and 120 may include a first housing 110 (e.g., first housing structure) coupled to the hinge mechanism (e.g., hinge mechanism 140 in FIG. 1B), and a second housing 120 (e.g., second housing structure) coupled to the hinge mechanism (e.g., hinge mechanism 140 in FIG. 1B). According to an embodiment, in the unfolded state, the first housing 110 may include a first surface 111 facing a first direction (e.g., front direction) (z-axis direction), and a second surface 112 facing a second direction (e.g., rear direction) (negative z-axis direction) opposite to the first surface 111. According to an embodiment, in the unfolded state, the second housing 120 may include a third surface 121 facing the first direction (z-axis direction), and a fourth surface 122 facing the second direction (negative z-axis direction). According to an embodiment, the electronic device 100 may be operated in such a manner that the first surface 111 of the first housing 110 and the third surface 121 of the second housing 120 face substantially the same first direction (z-axis direction) in the unfolded state, and the first surface 111 and the third surface 121 face one another in the folded state. According to an embodiment, the electronic device 100 may be operated in such a manner that the second surface 112 of the first housing 110 and the fourth surface 122 of the second housing 120 face substantially the same second direction (negative z-axis direction) in the unfolded state, and the second surface 112 and the fourth surface 122 face one another in opposite directions in the folded state. For example, in the folded state, the second surface 112 may face the first direction (z-axis direction), and the fourth surface 122 may face the second direction (negative z-axis direction).

According to certain embodiments, the first housing 110 may include a first side member 113 that at least partially forms an external appearance of the electronic device 100, and a first rear cover 114 coupled to the first side member 113 that forms at least a portion of the second surface 112 of the electronic device 100. According to an embodiment, the first side member 113 may include a first side surface 113a, a second side surface 113b extending from one end of the first side surface 113a, and a third side surface 113c extending from the other end of the first side surface 113a. According to an embodiment, the first side member 113 may be formed in a rectangular shape (e.g., square or rectangle) through the first side surface 113a, second side surface 113b, and third side surface 113c.

According to certain embodiments, the second housing 120 may include a second side member 123 that at least partially forms the external appearance of the electronic device 100, and a second rear cover 124 coupled to the second side member 123, forming at least a portion of the fourth surface 122 of the electronic device 100. According to an embodiment, the second side member 123 may include a fourth side surface 123a, a fifth side surface 123b extending from one end of the fourth side surface 123a, and a sixth side surface 123c extending from the other end of the fourth side surface 123a. According to an embodiment, the second side member 123 may be formed in a rectangular shape through the fourth side surface 123a, fifth side surface 123b, and sixth side surface 123c.

According to certain embodiments, the pair of housings 110 and 120 are not limited to the shape and combinations illustrated herein, and may be implemented with a combination of other shapes or parts. For example, in certain embodiments, the first side member 113 may be integrally formed with the first rear cover 114, and the second side member 123 may be integrally formed with the second rear cover 124.

According to certain embodiments, in the unfolded state of the electronic device 100, the second side surface 113b of the first side member 113 and the fifth side surface 123b of the second side member 123 may be connected without a gap formed therebetween. According to an embodiment, in the unfolded state of the electronic device 100, the third side surface 113c of the first side member 113 and the sixth side surface 123c of the second side member 123 may be connected without a gap formed therebetween. According to an embodiment, in the unfolded state, the electronic device 100 may be configured such that the combined length of the second side surface 113b and the fifth side surface 123b is longer than the combined length of the first side surface 113a and/or the fourth side surface 123a. In addition, the combined length of the third side surface 113c and the sixth side surface 123c may be configured to be longer than the length of the first side surface 113a and/or the fourth side surface 123a.

According to certain embodiments, the first side member 113 and/or the second side member 123 may be formed of a metal, and may further include a polymer injected into the metal. According to an embodiment, the first side member 113 and/or the second side member 123 may include at least one conductive portion 116 and/or 126 electrically segmented through one or more segmenting portions 1161 and 1162 and/or segmenting 1261 and 1262, which may be formed using a polymer. In this case, the at least one conductive portion may be electrically connected to a wireless communication circuit included in the electronic device 100, and may be used as an antenna operating in at least one designated band (e.g., legacy band).

According to certain embodiments, the first rear cover 114 and/or the second rear cover 124 may be formed of, for example, coated or tinted glass, ceramic, polymer, metal (e.g., aluminum, stainless steel or “STS”, or magnesium), or a combination thereof.

According to certain embodiments, the flexible display 400 may be disposed to extend from the first surface 111 of the first housing 110 across the hinge mechanism (e.g., hinge mechanism 140 in FIG. 1B) to at least a portion of the third surface 121 of the second housing 120. For example, the flexible display 400 may include a first region 130a substantially corresponding to the first surface 111, a second region 130b corresponding to the second surface 112, and a third region 130c (e.g., the bendable region) connecting the first region 130a and the second region 130b and corresponding to the hinge mechanism (e.g., hinge mechanism 140 in FIG. 1B). According to an embodiment, the electronic device 100 may include a first protection cover 115 (e.g., first protection frame or first decoration member) coupled along the periphery of the first housing 110. According to an embodiment, the electronic device 100 may include a second protection cover 125 (e.g., second protection frame or second decoration member) coupled along the periphery of the second housing 120. According to an embodiment, the first protection cover 115 and/or the second protection cover 125 may be formed of a metal or polymer material. According to an embodiment, the first protection cover 115 and/or the second protection cover 125 may be used as a decorative member. According to an embodiment, the flexible display 400 may be positioned such that the periphery of the first region 130a is interposed between the first housing 110 and the first protection cover 115. According to an embodiment, the flexible display 400 may be positioned such that the periphery of the second region 130b is interposed between the second housing 120 and the second protection cover 125. According to an embodiment, the flexible display 400 may be positioned such that the periphery of the flexible display 400 corresponding to a protection cap 135 is protected through the protection cap disposed in a region corresponding to the hinge mechanism (e.g., hinge mechanism 140 in FIG. 1B). Consequently, the periphery of the flexible display 400 may be substantially protected from the outside. According to an embodiment, the electronic device 100 may include a hinge housing 141 (e.g., hinge cover) that is disposed so as to support the hinge mechanism (e.g., hinge mechanism 140 in FIG. 1B). The hinge housing 141 may further be exposed to the outside when the electronic device 100 is in the folded state, and be invisible as viewed from the outside when retracted into a first space (e.g., internal space of the first housing 110) and a second space (e.g., internal space of the second housing 120) when the electronic device 100 is in the unfolded state. In certain embodiments, the flexible display 400 may be disposed to extend from at least a portion of the second surface 112 to at least a portion of the fourth surface 122. In this case, the electronic device 100 may be folded so that the flexible display 400 is exposed to the outside (out-folding scheme).

According to certain embodiments, the electronic device 100 may include a sub-display 131 disposed separately from the flexible display 400. According to an embodiment, the sub-display 131 may be disposed to be at least partially exposed on the second surface 112 of the first housing 110, and may display status information of the electronic device 100 in place of the display function of the flexible display 400 in case of the folded state. According to an embodiment, the sub-display 131 may be disposed to be visible from the outside through at least some region of the first rear cover 114. In certain embodiments, the sub-display 131 may be disposed on the fourth surface 122 of the second housing 120. In this case, the sub-display 131 may be disposed to be visible from the outside through at least some region of the second rear cover 124.

According to certain embodiments, the electronic device 100 may include at least one of an input device 103 (e.g., microphone), sound output devices 101 and 102, a sensor module 104, camera devices 105 and 108, a key input device 106, or a connector port 107. In the illustrated embodiment, the input device 103 (e.g., microphone), sound output devices 101 and 102, sensor module 104, camera devices 105 and 108, key input device 106, and connector port 107 indicate a hole or shape formed in the first housing 110 or the second housing 120, but may be defined to include a substantial electronic component (e.g., input device, sound output device, sensor module, or camera device) that is disposed inside the electronic device 100 and operated through a hole or a shape.

According to certain embodiments, the input device 103 may include at least one microphone disposed on the second housing 120. In certain embodiments, the input device 103 may include a plurality of microphones disposed to detect the direction of a sound. In certain embodiments, a plurality of microphones may be disposed at appropriate positions in the first housing 110 and/or the second housing 120. According to an embodiment, the sound output devices 101 and 102 may include speakers. According to an embodiment, the input device 103 may include a receiver for calls disposed in the first housing 110, and a speaker disposed in the second housing 120. In certain embodiments, the input device 103, the sound output devices 101 and 102, and the connector port 107 may be disposed in a space arranged in the first housing 110 and/or the second housing 120 of the electronic device 100, and may be exposed to the external environment through at least one hole formed in the first housing 110 and/or the second housing 120. According to an embodiment, at least one connector port 107 may be used to transmit and receive power and/or data to and from an external electronic device. In certain embodiments, at least one connector port (e.g., ear jack hole) may accommodate a connector (e.g., ear jack) for transmitting and receiving an audio signal to and from an external electronic device. In certain embodiments, the hole formed in the first housing 110 and/or the second housing 120 may be commonly used for the input device 103 and the sound output devices 101 and 102. In certain embodiments, the sound output devices 101 and 102 may include a speaker (e.g., piezo speaker) that operates without using a hole formed in the first housing 110 and/or the second housing 120.

According to certain embodiments, the sensor module 104 may generate an electrical signal or data value corresponding to an internal operating state of the electronic device 100 or an external environmental state. The sensor module 104 may detect an external environment, for example, through the first surface 111 of the first housing 110. In certain embodiments, the electronic device 100 may further include at least one sensor module disposed to detect an external environment through the second surface 112 of the first housing 110. According to an embodiment, the sensor module 104 (e.g., illuminance sensor) may be disposed under the flexible display 400 to detect an external environment through the flexible display 400. According to an embodiment, the sensor module 104 may include at least one of a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, an illuminance sensor, a proximity sensor, a biometric sensor, an ultrasonic sensor, or an illuminance sensor 104.

According to certain embodiments, the camera devices 105 and 108 may include a first camera device 105 (e.g., front camera device) disposed on the first surface 111 of the first housing 110, and a second camera device 108 disposed on the second surface 112 of the first housing 110. The electronic device 100 may further include a flash 109 disposed close to the second camera device 108. According to an embodiment, the camera device 105 or 108 may include one or more lenses, an image sensor, and/or an image signal processor. The flash 109 may include, for example, a light emitting diode or a xenon lamp. According to an embodiment, the camera devices 105 and 108 may be arranged so that two or more lenses (e.g., wide-angle lens, super-wide-angle lens, or telephoto lens) and image sensors are positioned on one surface (e.g., first surface 111, second surface 112, third surface 121, or fourth surface 122) of the electronic device 100. In certain embodiments, the camera devices 105 and 108 may include time-of-flight (TOF) lenses and/or an image sensor.

According to certain embodiments, the key input device 106 (e.g., key button) may be disposed on the third side surface 113c of the first side member 113 of the first housing 110. In certain embodiments, the key input device 106 may be disposed on at least one of the other side surfaces 113a and 113b of the first housing 110 and/or the side surfaces 123a, 123b and 123c of the second housing 120. In certain embodiments, the electronic device 100 may not include some or all of the key input devices 106, and those not included key input devices 106 may be implemented in other forms, such as soft keys, on the flexible display 400. In certain embodiments, the key input device 106 may be implemented by using a pressure sensor included in the flexible display 400.

According to certain embodiments, some of the camera devices 105 and 108 (e.g., first camera device 105) or the sensor module 104 may be disposed to be exposed through the flexible display 400. For example, the first camera device 105 or the sensor module 104 may be arranged in the internal space of the electronic device 100 so as to be in contact with the external environment through an opening (e.g., through hole) formed at least partially in the flexible display 400. In another embodiment, some sensor modules 104 may be arranged in the internal space of the electronic device 100 so as to perform their functions without being visually exposed through the flexible display 400. For example, in this case, the opening of a region of the flexible display 400 facing the sensor module may be not needed.

With reference to FIG. 2B, the electronic device 100 may be operated to remain in an intermediate state through the hinge mechanism (e.g., hinge 140 in FIG. 1B). In this case, the electronic device 100 may control the flexible display 400 to display different pieces of content on the display area corresponding to the first surface 111 and the display area corresponding to the third surface 121. According to an embodiment, the electronic device 100 may be operated substantially in an unfolded state (e.g., unfolded state of FIG. 1A) and/or substantially in a folded state (e.g., folded state of FIG. 2A) with respect to a specific inflection angle (e.g., angle between the first housing 110 and the second housing 120 in the intermediate state) through the hinge mechanism (e.g., hinge mechanism 140 in FIG. 1B). For example, when a pressing force is applied in the unfolding direction (B direction) in a state where the electronic device 100 is unfolded at a specific inflection angle, through the hinge mechanism (e.g., hinge mechanism 140 in FIG. 1B), the electronic device 100 may be transitioned to an unfolded state (e.g., unfolded state of FIG. 1A). For example, when a pressing force is applied in the folding direction (C direction) in a state where the electronic device 100 is unfolded at a specific inflection angle, through the hinge mechanism (e.g., hinge mechanism 140 in FIG. 1B), the electronic device 100 may be transitioned to a closed state (e.g., folded state of FIG. 2A). In an embodiment, the electronic device 100 may be operated to remain in an unfolded state at various angles (not shown) through the hinge mechanism (e.g., hinge mechanism 140 in FIG. 1B).

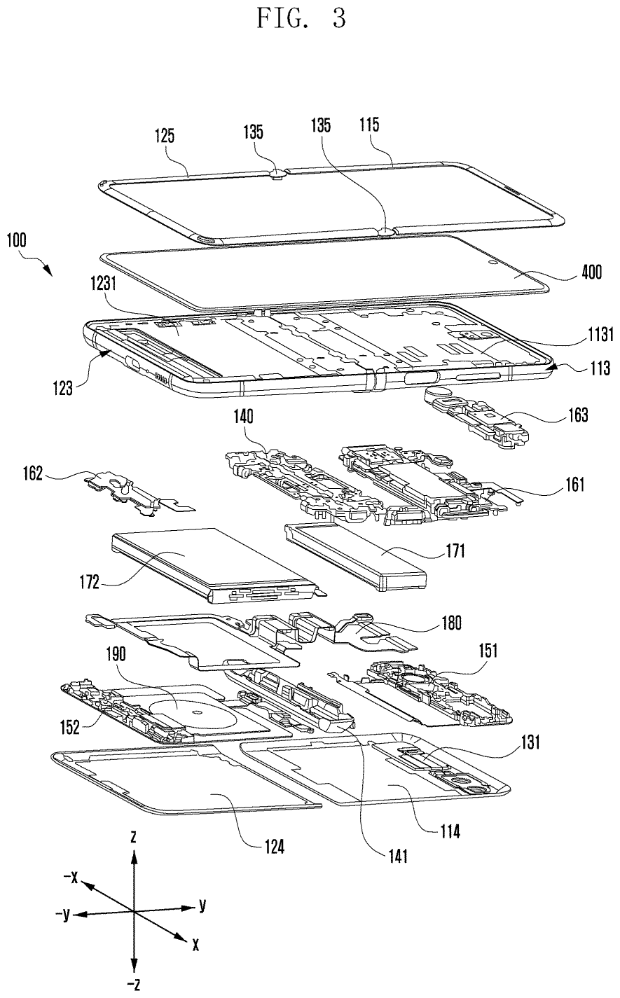

FIG. 3 is an exploded perspective view of the electronic device according to certain embodiments of the disclosure.

With reference to FIG. 3, the electronic device 100 may include a first side member 113 (e.g., first side frame), a second side member 123 (e.g., second side frame), and a hinge mechanism 140 (e.g., hinge module) rotatably connecting the first side member 113 and the second side member 123. According to an embodiment, the electronic device 100 may include a first support member 1131 (e.g., first support member) at least partially extending from the first side member 113, and a second support member 1231 at least partially extending from the second side member 123. According to an embodiment, the first support member 1131 may be integrally formed with the first side member 113 or may be structurally coupled to the first side member 113. Similarly, the second support member 1231 may be integrally formed with the second side member 123 or may be structurally coupled to the second side member 123. According to an embodiment, the electronic device 100 may include a flexible display 400 disposed to be supported by the first support member 1131 and the second support member 1231. According to an embodiment, the electronic device 100 may include a first rear cover 114 that is coupled to the first side member 113 and provides a first space between itself and the first support member 1131, and a second rear cover 124 that is coupled to the second side member 123 and provides a second space between itself and the second support member 1231. In certain embodiments, the first side member 113 and the first rear cover 114 may be integrally formed. In certain embodiments, the second side member 123 and the second rear cover 124 may be integrally formed. According to an embodiment, the electronic device 100 may include a first housing 110 (e.g., first housing 110 in FIG. 1A) (e.g., first housing structure) provided through the first side member 113, the first support member 1131, and the first rear cover 114. According to an embodiment, the electronic device 100 may include a second housing (e.g., second housing 120 in FIG. 1A) (e.g., second housing structure) provided through the second side member 123, the second support member 1231, and the second rear cover 124. According to an embodiment, the electronic device 100 may include a sub-display 131 that is disposed to be visible from the outside through at least some region of the first rear cover 114.

According to certain embodiments, the electronic device 100 may include a first substrate assembly 161 (e.g., main printed circuit board), a camera assembly 163, a first battery 171, or a first bracket 151, arranged in the first space between the first side member 113 and the first rear cover 114. According to an embodiment, the camera assembly 163 may include a plurality of camera devices (e.g., camera devices 105 and 108 in FIGS. 1A and 2A), and may be electrically connected to the first substrate assembly 161. According to an embodiment, the first bracket 151 may provide a support structure for supporting the first substrate assembly 161 and/or the camera assembly 163, and improved rigidity. According to an embodiment, the electronic device 100 may include a second board assembly 162 (e.g., sub printed circuit board), an antenna 190 (e.g., coil member), a second battery 172, or a second bracket 152, arranged in the second space between the second side member 123 and the second rear cover 124. According to an embodiment, the electronic device 100 may include a wiring member 180 (e.g., FPCB) extending from the first substrate assembly 161 across the hinge mechanism 140 to a plurality of electronic components arranged between the second side member 123 and the second rear cover 124, to provide electrical connections therebetween. According to an embodiment, the antenna 190 may include a near field communication (NFC) antenna, a wireless charging antenna, and/or a magnetic secure transmission (MST) antenna. The antenna 190 may, for example, perform short-range communication with an external device or wirelessly transmit and receive power utilized for charging.

According to certain embodiments, the electronic device 100 may include a hinge housing 141 (e.g., hinge cover) that supports the hinge mechanism 140 and is disposed so as to be exposed to the outside when the electronic device 100 is in the folded state (e.g., folded state of FIG. 2A) and be invisible from the outside by being retracted into the first space and/or the second space when the electronic device 100 is in the unfolded state (e.g., unfolded state of FIG. 1A).

According to certain embodiments, the electronic device 100 may include a first protection cover 115 coupled along the periphery of the first side member 113. According to an embodiment, the electronic device 100 may include a second protection cover 125 coupled along the periphery of the second side member 123. According to an embodiment, in the flexible display 400, the periphery of a first flat portion (e.g., first flat portion 130a in FIG. 1B) may be protected by the first protection cover 115. According to an embodiment, in the flexible display 400, the periphery of a second flat portion (e.g., second flat portion 130b in FIG. 1B) may be protected by the second protection cover 125. According to an embodiment, the electronic device 100 may include a protection cap 135 that protects the periphery of the third region (e.g., third region 130c in FIG. 1B) of the flexible display 400 corresponding to the hinge mechanism 140.

According to certain embodiments, the first support member 1131 may include a first support surface facing a first direction (z-axis direction), and a second support surface facing a second direction (negative z-axis direction) opposite to the first direction. According to an embodiment, the second support member 1231 may include a third support surface facing the first direction, and a fourth support surface facing the second direction in the unfolded state. According to an embodiment, the flexible display 400 may be supported by the first support surface of the first support member 1131 and the third support surface of the second support member 1231.

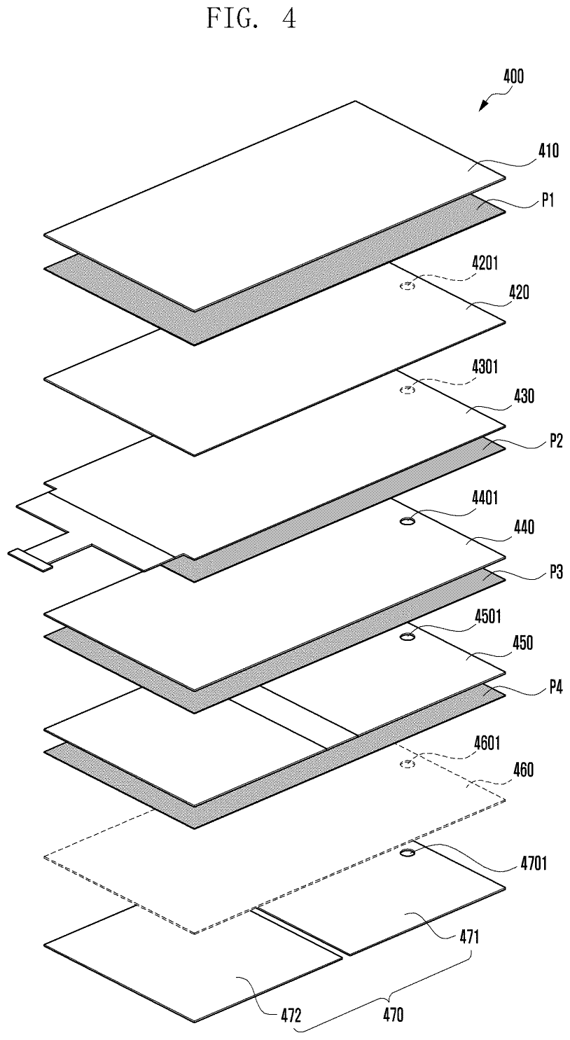

FIG. 4 is an exploded perspective view illustrating a flexible display according to various embodiments of the disclosure.

A flexible display 400 according to embodiments of the disclosure may include an unbreakable (UB) type OLED display (e.g., a curved display).

With reference to FIG. 4, the flexible display 400 may include a window layer 410 and also include a polarization layer 420 (polarizer (POL)) (e.g., a polarizing film), a display panel 430, a polymer layer 440, a metal sheet layer 450, and a reinforcing plate 470 which are sequentially disposed on the rear surface of the window layer 410. In some embodiments, the flexible display 400 may further include a digitizer 460 disposed between the polymer layer 440 and the metal sheet layer 450 or between the metal sheet layer 450 and the reinforcing plate 470.

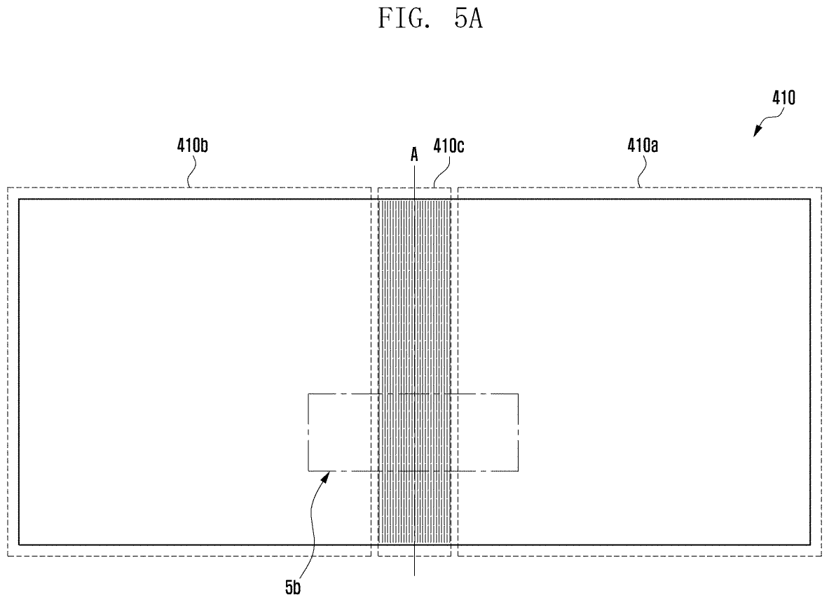

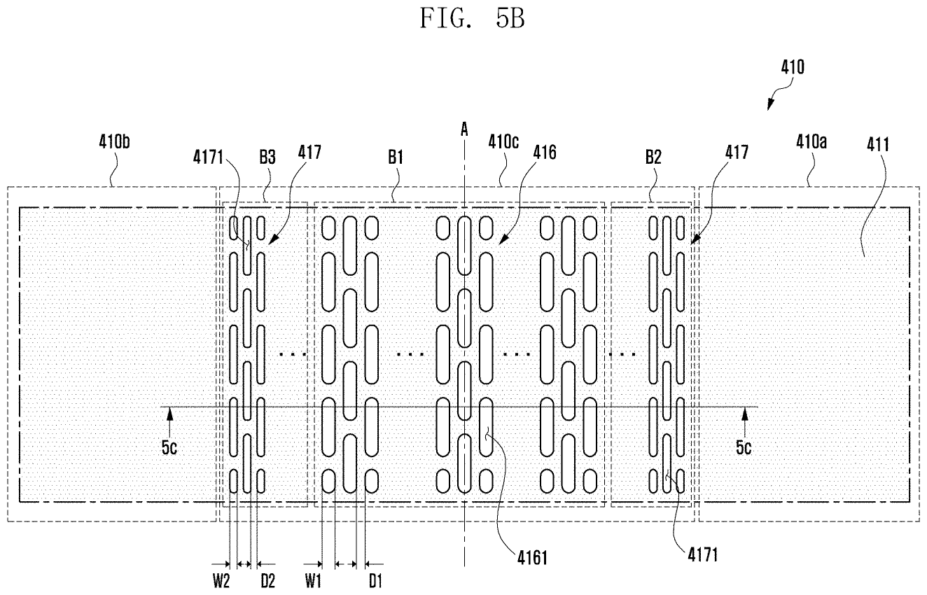

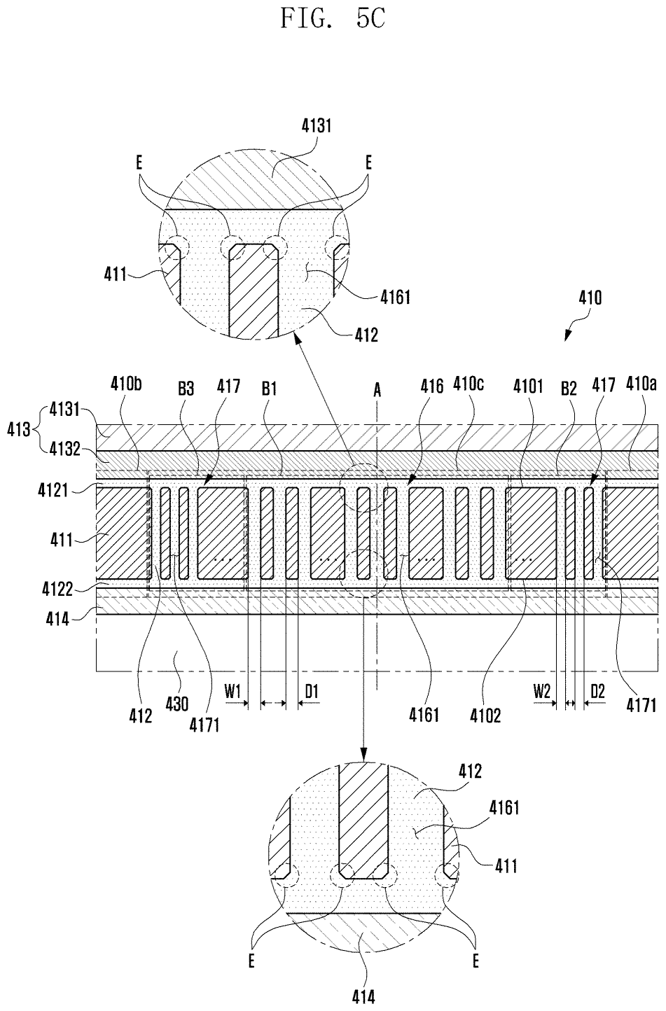

According to various embodiments, the window layer 410 may include a glass layer (e.g., a glass layer 411 in FIG. 5C). According to an embodiment, the glass layer (e.g., the glass layer 411 in FIG. 5C) may have a plurality of openings (e.g., a plurality of openings 4161 and 4171 in FIG. 5C) disposed in a region corresponding to a bendable third portion (e.g., the third portion 130c in FIG. 1B) of the flexible display 400, so that the bendability of the flexible display 400 can be improved. According to an embodiment, the plurality of openings 4161 and 4171 are disposed to have different opening ratios for respective regions divided based on the folding axis ‘A’, thereby providing bendability corresponding to the curvature of each bent region, and helping smooth bending operation and rigidity reinforcement of the window layer 410.

According to various embodiments, the window layer 410, the polarization layer 420, the display panel 430, the polymer layer 440, and the metal sheet layer 450 may be disposed to cross at least a portion of a first surface (e.g., the first surface 111 in FIG. 1A) of a first housing (e.g., the first housing 110 in FIG. 1A) and a third surface (e.g., the third surface 121 in FIG. 1A) of a second housing (e.g., the second housing 120 in FIG. 1A). According to an embodiment, the reinforcing plate 470 may include a first reinforcing plate 471 corresponding to the first housing (e.g., the first housing 110 in FIG. 1A) and a second reinforcing plate 472 corresponding to the second housing (e.g., the second housing 120 in FIG. 1A). According to an embodiment, the window layer 410, the polarization layer 420, the display panel 430, the polymer layer 440, the metal sheet layer 450, and the reinforcing plate 470 may be attached to each other through adhesives P1, P2, P3, and P4. For example, the adhesives P1, P2, P3, and P4 may include at least one of an optical clear adhesive (OCA), a pressure sensitive adhesive (PSA), a heat-responsive adhesive, a normal adhesive, and a double-sided tape.

According to various embodiments, the display panel 430 may include a plurality of pixels and a wiring structure (e.g., an electrode pattern). According to an embodiment, the polarization layer 420 may selectively pass light generated from a light source of the display panel 430 and vibrating in a predetermined direction. According to an embodiment, the display panel 430 and the polarization layer 420 may be integrally formed. According to an embodiment, the flexible display 400 may include a touch panel (not shown).

According to various embodiments, the polymer layer 440 may be disposed under the display panel 430 to provide a dark background for ensuring visibility of the display panel 430, and formed of a buffer material for a buffering action. In some embodiments, for waterproofing the flexible display 400, the polymer layer 440 may be removed or disposed under the metal sheet layer 450.

According to various embodiments, the metal sheet layer 450 may be formed in a shape that provides bendability to the flexible display 400. According to an embodiment, the metal sheet layer 450 may include at least one of steel use stainless (SUS) (e.g., stainless steel (STS)), Cu, Al, or a metal clad (e.g., a stack member in which SUS and Al are alternately disposed). In some embodiments, the metal sheet layer 450 may include any other alloy material. In some embodiments, the metal sheet layer 450 can help reinforce the rigidity of an electronic device (e.g., the electronic device 100 in FIG. 1A), shield ambient noise, and dissipate heat emitted from nearby heat-generating components.

According to various embodiments, the flexible display 400 may include the digitizer 460 as a detection member disposed under the metal sheet layer 450 and receiving an input of an electronic pen (e.g., a stylus). For example, the digitizer 460 may include a coil member disposed on a dielectric substrate to detect the resonance frequency of the electromagnetic induction scheme applied from the electronic pen.

According to various embodiments, the flexible display 400 may include at least one functional member (not shown) disposed between the polymer layer 440 and the metal sheet layer 450 or below the metal sheet layer 450. According to an embodiment, the functional member may include a graphite sheet for heat dissipation, an added display, a force-touch FPCB, a fingerprint sensor FPCB, an antenna radiator for communication, or a conductive/non-conductive tape. According to an embodiment, when bending is not possible, the functional member may be individually disposed in the first housing (e.g., the first housing 110 in FIG. 1A) and the second housing (e.g., the second housing 120 in FIG. 1A). According to an embodiment, when bending is possible, the functional member may be disposed from the first housing (e.g., the first housing 110 in FIG. 1A) up to at least a portion of the second housing (e.g., the second housing 120 in FIG. 1A), passing through a hinge (e.g., the hinge 140 in FIG. 1B).

According to various embodiments, the electronic device (e.g., the electronic device 100 in FIG. 1A) may include a camera device (e.g., the first camera device 105 in FIG. 1A) that is disposed under the flexible display 400 and detects an external environment through the flexible display 400. In some embodiments, the electronic device (e.g., the electronic device 100 in FIG. 1A) may include at least one sensor module (e.g., the sensor module 104 in FIG. 1A) (e.g., an illuminance sensor, a proximity sensor, or a TOF sensor) disposed under the flexible display 400. According to an embodiment, the polarization layer 420, the display panel 430, the polymer layer 440, the metal sheet layer 450, the digitizer 460, and the reinforcing plate 470 may have through-holes 4201, 4301, 4401, 4501, 4601, and 4701. In some embodiments, the display panel 430 and/or the polarization layer 420 may not need the through-holes 4201 and 4301 through adjustment in the transmittance of corresponding regions. In some embodiments, the sizes of the through-holes 4201, 4301, 4401, 4501, 4601, and 4701 may be determined based on a size of the camera device (e.g., the first camera device 105 in FIG. 1A) and/or an angle of view of the camera device (e.g., the first camera device 105 in FIG. 1A), and the respective sizes of the through-holes 4201, 4301, 4401, 4501, 4601, and 4701 may be different from each other.

FIG. 5A is a plan view illustrating a window layer according to various embodiments of the disclosure. FIG. 5B is an enlarged view illustrating a region 5b of FIG. 5A according to various embodiments of the disclosure. FIG. 5C is a partial cross-sectional view of the window layer taken along a line 5c-5c of FIG. 5B according to various embodiments of the disclosure.

With reference to FIGS. 5A to 5C, the window layer 410 may include a first region 410a corresponding to a first portion (e.g., the first portion 130a in FIG. 1B) corresponding to a first housing (e.g., the first housing 110 in FIG. 1B) of an electronic device (e.g., the electronic device 100 in FIG. 1B), a second region 410b corresponding to a second portion (e.g., the second portion 130b in FIG. 1B) corresponding to a second housing (e.g., the second housing 120 in FIG. 1B), and a third region 410c corresponding to a third portion (e.g., the third portion 130c in FIG. 1B) corresponding to a hinge (e.g., the hinge 140 in FIG. 1B). According to an embodiment, the third region 410c may be bendable together with a display panel (e.g., the display panel 430 in FIG. 4) in response to a folding operation of the electronic device (e.g., the electronic device 100 in FIG. 1B).

According to various embodiments, the third region 410c of the window layer 410 may include a first sub-region B1 containing the folding axis ‘A’ and also include second sub-regions B2 and B3 respectively disposed with the first sub-region B1 interposed therebetween. According to an embodiment, the first sub-region B1 may exhibit a first bendability, and the second sub-regions B2 and B3 may exhibit a second bendability different from the first bendability. For example, the third region 410c may be formed to have bendability corresponding to the curvature of each bent region. In some embodiments, the third region 410c may be configured to change a bendability gradually (tangentially) in a direction towards the first sub-region B1 to the second sub-regions B2 and B3.

According to various embodiments, the window layer 410 may include the glass layer 411 having a first surface 4101 facing the outside of the electronic device (e.g., the electronic device 100 in FIG. 1A) and a second surface 4102 facing the display panel (e.g., the display panel 430 in FIG. 4) opposite to the first surface 4101. According to an embodiment, the glass layer 411 may be formed to have a thickness ranging from 0.1 mm to 0.5 mm, thereby helping to reinforce the rigidity of the flexible display (e.g., the flexible display 400 in FIG. 4). For example, the glass layer 411 may be formed to have a thickness of about 0.2 mm. According to an embodiment, the window layer 410 may include at least one protective layer 413 stacked on the first surface 4101 of the glass layer 411, and an impact absorbent layer 414 stacked on the second surface 4102. According to an embodiment, the at least one protective layer 413 may include an additional glass layer 4132 (e.g., ultra-thin glass, UTG) stacked on the first surface 4101, and a first polymer layer 4131 stacked on the additional glass layer 4132. According to an embodiment, the first polymer layer 4131 may be formed of PET or PI. In a certain embodiment, the at least one protective layer 413 may include only the first polymer layer. According to an embodiment, the impact absorbent layer 414 may be formed of PET as a second polymer layer.

According to various embodiments, the glass layer 411 may include a first pattern 416 of a plurality of first openings 4161 formed to penetrate from the first surface 4101 to the second surface 4102 in a region corresponding to the first sub-region B1, and a second pattern 417 of a plurality of second openings 4171 formed to penetrate from the first surface 4101 to the second surface 4102 in regions corresponding to the second sub-regions B2 and B3. According to an embodiment, the plurality of first openings 4161 and the plurality of second openings 4171 may be formed through a process such as laser or etching. According to an embodiment, the first sub-region B1 and the second sub-regions B2 and B3 may be configured to exhibit different bendabilities through the plurality of first openings 4161 and the plurality of second openings 4171. For example, in a foldable electronic device (e.g., the electronic device 100 in FIG. 1B), because the curvature decreases outward from the folding axis A1 (e.g., in a direction away from the folding axis A1), the bendability may increase inward towards the folding axis A1. Therefore, the bendability of the first sub-region B1 may be greater than that of the second sub-regions B2 and B3. In this case, the bendability of the first sub-region B1 and the bendability of the second sub-regions B2 and B3 may be determined depending on the opening ratios of the plurality of first openings 4161 and the plurality of second openings 4171 in each region. For example, the opening ratio of the glass layer 411 corresponding to the first sub-region B1 may be greater than that of the glass layer 411 corresponding to the second sub-regions B2 and B3. According to an embodiment, the bendability may also be determined through a shape and/or an arrangement structure (e.g., a separation distance and/or an arrangement density) of the plurality of first and second openings 4161 and 4171. For example, in case of the same arrangement distance, a first width W1 of each of the first openings 4161 is greater than a second width W2 of each of the second openings 4171. In another example, in case of the same width, a first distance D1 between the first openings 4161 may be smaller than a second distance D2 between the second openings 4171. According to an embodiment, the bendability may also be determined by the number of the first and second openings 4161 and 4171. For example, the number of the plurality of first openings 4161 may be greater than the number of the plurality of second openings 4171.

According to various embodiments, the window layer 410 may include a filling member 412 that fills the plurality of openings 4161 and 4171 formed in the glass layer 411. According to an embodiment, the filling member 412 may include a material having elasticity. According to an embodiment, the filling member 412 may include a substantially transparent material, which initially fills the plurality of openings 4161 and 4171 in the form of a liquid or semi-solid state and is cured over time by irradiation with light or by chemical treatment. According to an embodiment, the filling member 412 may include a resin such as silicone, urethane, or acrylic. According to an embodiment, the filling member 412 may include a material having a refractive index that is substantially equal to that of the glass layer 411, so that the plurality of openings 4161 and 4171 may not be visually seen from the outside. In some embodiments, the filling member 412 disposed in the first sub-region B1 and the filling member 412 disposed in the second sub-regions B2 and B3 may include different materials. For example, when the widths of the plurality of openings 4161 and 4171 are applied differently depending on the bending characteristics for each region, the region having of a higher bendability may use a medium having a higher modulus of elasticity due to a relatively large pattern change rate.

According to an embodiment, the window layer 410 may include a first planarization layer 4121 stacked on the first surface 4101 to a specified thickness, and a second planarization layer 4122 stacked on the second surface 4102 to a specified thickness. In some embodiments, the first planarization layer 4121 and/or the second planarization layer 4122 may be omitted. According to an embodiment, the first and second planarization layers 4121 and 4122 may be disposed to allow the first and second surfaces 4101 and 4102 roughened by the filling member 412 filled in the plurality of openings 4161 and 4171 to have substantially flat surfaces, and to protect the glass layer 411. According to an embodiment, the first and second planarization layers 4121 and 4122 may be formed of a material identical with that of the filling member 412. In this case, the first and second planarization layers 4121 and 4122 may be formed together when the filling member 412 is filled. In some embodiments, the first and second planarization layers 4121 and 4122 may be formed of a material different from that of the filling member 412. According to an embodiment, the first and second planarization layers 4121 and 4122 may be formed to have a thickness in the range of 0.01 mm to 0.1 mm. For example, the first and second planarization layers 4121 and 4122 may be formed to have a thickness of about 0.01 mm. According to an embodiment, the first and second planarization layers 4121 and 4122 may be formed to have a hardness value in the range of 20 Shore D to 50 Shore D. According to an embodiment, the first planarization layer 4121 and/or the second planarization layer 4122 may be stacked to extend up to the outer surface of the glass layer 411 corresponding to the first and second regions 410a and 410b of the window layer 410. According to various embodiments, in the glass layer 411, edge portions (portions ‘E’ in FIG. 5C) where the plurality of openings 4161 and 4171 start may be tapered or curved, thereby helping to minimize the visibility of the boundaries of the plurality of openings 4161 and 4171 from the outside.

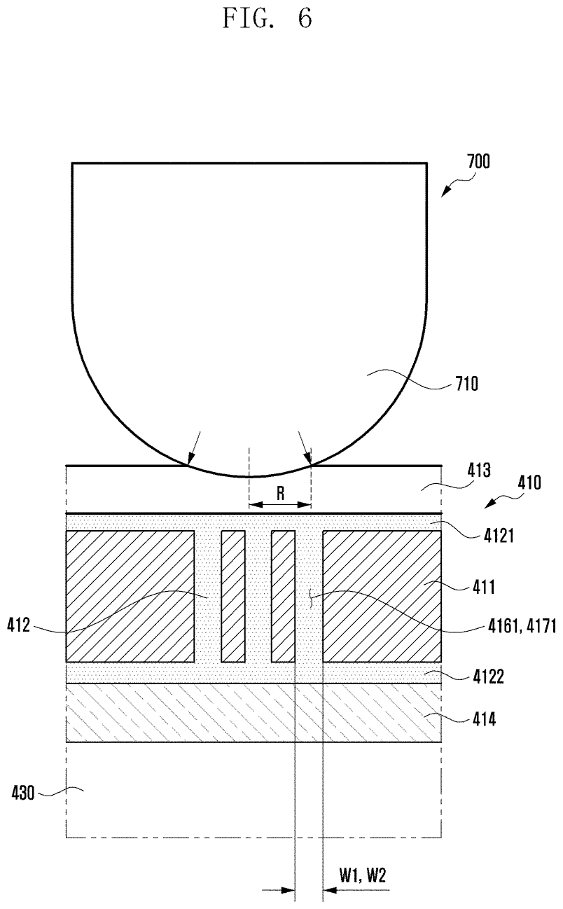

FIG. 6 is a partial cross-sectional view of a window layer having a plurality of openings determined depending on a pen tip of an electronic pen according to various embodiments of the disclosure.

With reference to FIG. 6, the flexible display (e.g., the flexible display 400 in FIG. 4) may include the digitizer (e.g., the digitizer 460 in FIG. 4) for detecting an input of the electronic pen 600. In this case, the window layer 410 of the flexible display 400 may have a robust structure that can withstand the pressure of the pen tip 710 of the electronic pen 700. According to an embodiment, the plurality of openings 4161 and 4171, for example, the first width W1 of each of the first openings 4161 and the second width W2 of each of the second openings 4171, may be determined within a range capable of preventing deformation through the protective layer 413 even when the window layer 410 is pressed by the pen tip 710 of the electronic pen 700. For example, the width W1 or W2 of each of the plurality of openings 4161 and 4171 may be determined within a radius R of a contact area of the pen tip 710 in contact with the protective layer 413.

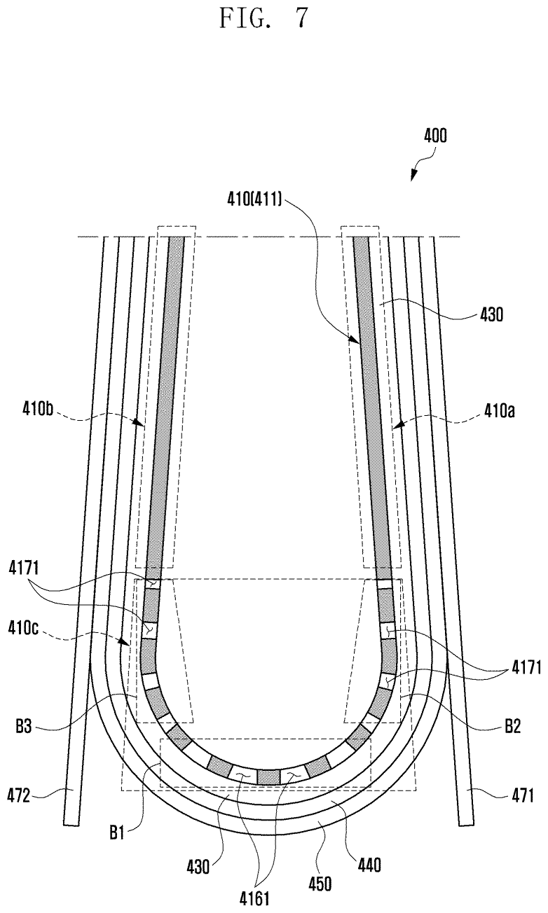

FIG. 7 is a view illustrating a folding state of a flexible display according to various embodiments of the disclosure.

With reference to FIG. 7, when the electronic device (e.g., the electronic device 100 in FIG. 2A) is in the folding state, the flexible display 400 may be deformed such that the window layer 410, the display panel 430, the polymer layer 440, and the metal sheet layer 450 are folded together except for the first and second reinforcing plates 471 and 472 disposed to be separated from each other. According to an embodiment, in the folding state, the window layer 410 may be folded such that the first and second regions 410a and 410b generally face each other and the third region 410c has a specified curvature. In this case, the glass layer 411 corresponding to the third region 410c of the window layer 410 may be bent in the first sub-region B1 having a first bendability through the plurality of first openings 4161 and in the second sub-regions B2 and B3 having a second bendability smaller than the first bendability through the plurality of second openings 4171. In this case, the third region 410c of the window layer 410 not only provides smooth bendability, but also helps to reinforce the rigidity of the glass layer 411 because the second sub-regions B2 and B3 are formed to have a lower opening ratio than the first sub-region B1.

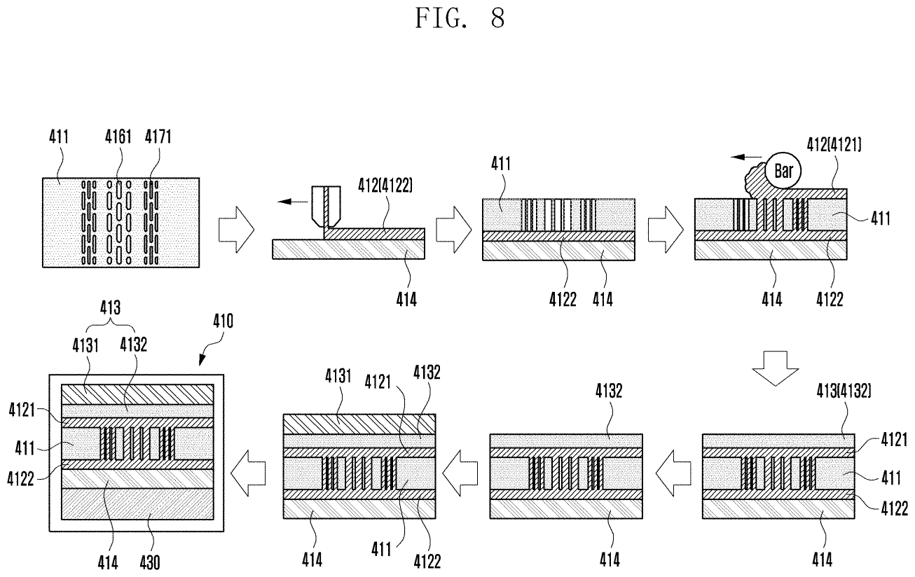

FIG. 8 is a view illustrating a manufacturing process of a flexible display according to various embodiments of the disclosure.

With reference to FIG. 8, at the outset, the glass layer 411 having the plurality of openings 4161 and 4171 formed therein may be prepared. For example, the plurality of openings 4161 and 4171 may be formed through a laser process or an etching process. Thereafter, a base substrate such as a PET film is used as the impact absorbent layer 414, the filling member 412 may be coated thereon. According to an embodiment, the filling member 412 may include a resin such as silicone, urethane, or acrylic in a liquid state. According to an embodiment, when the coated filling member 412 is cured, the coated filling member 412 may be used as the second planarization layer 4122. Thereafter, the glass layer 411 is stacked on the second planarization layer 4122, and the liquid filling member 412 may be coated thereon again. The filling member 412 is liquefied enough to fill the plurality of openings 4161 and 4171 formed in the glass layer 411, and may be sufficiently coated on the glass layer 411 to have a specified thickness. For example, the filling member 412 may be sufficiently filled in the plurality of openings 4161 and 4171 and formed to have a specified thickness on the glass layer 411, and the solidified filling member 412 may be used as the first planarization layer 4121. Thereafter, the protective layer 413 such as the additional glass layer 4132 (e.g., ultra-thin glass, UTG) and/or the polymer layer 4131 is stacked on the solidified first planarization layer 4121, and as a result, the window layer 410 is formed.

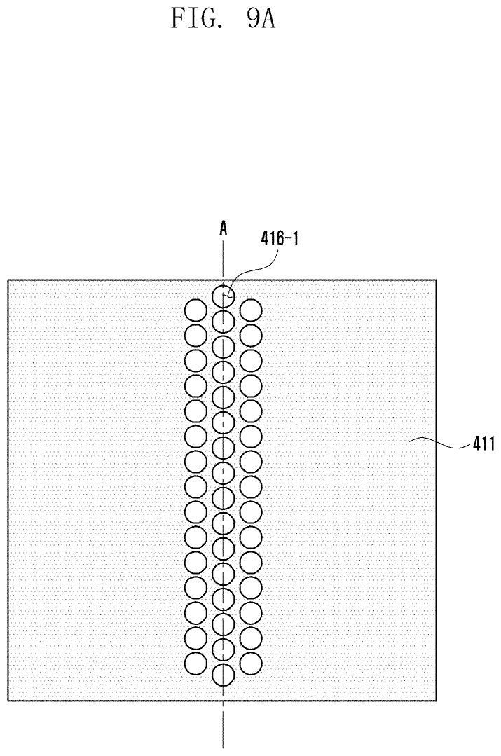

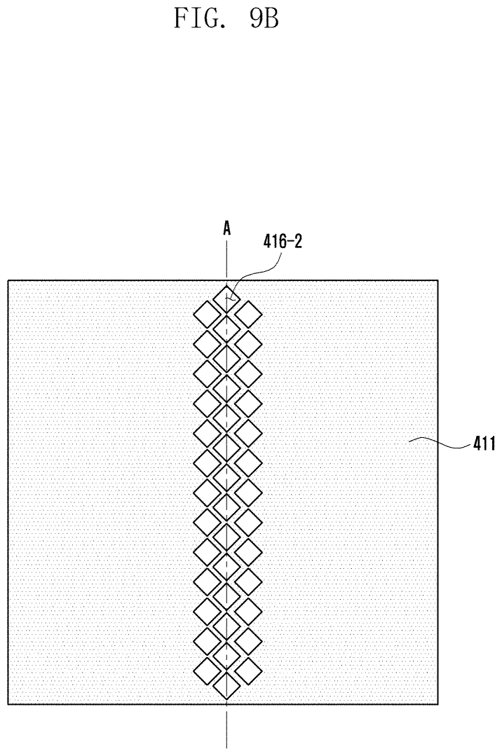

FIGS. 9A and 9B are partial plan views of a glass layer having a plurality of openings according to various embodiments of the disclosure.

With reference to FIG. 9A, the glass layer 411 may have a plurality of circular openings 416-1 arranged at predetermined intervals in a longitudinal direction along the folding axis A.

With reference to FIG. 9B, the glass layer may have a plurality of rhombus-shaped openings 416-2 arranged at predetermined intervals in a longitudinal direction along the folding axis A.

According to various embodiments, the plurality of openings may be formed in various shapes other than a circular shape or a rhombus shape. In some embodiments, the plurality of openings may include openings having the same shape arranged at predetermined intervals. In some embodiments, the plurality of openings may include openings having different shapes. In some embodiments, the plurality of openings may be arranged at different intervals and formed in different shapes.

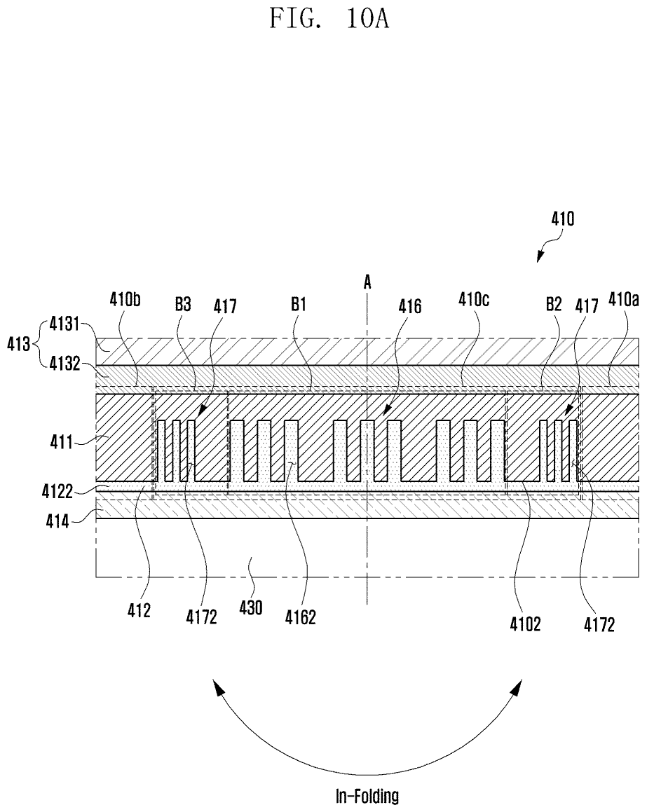

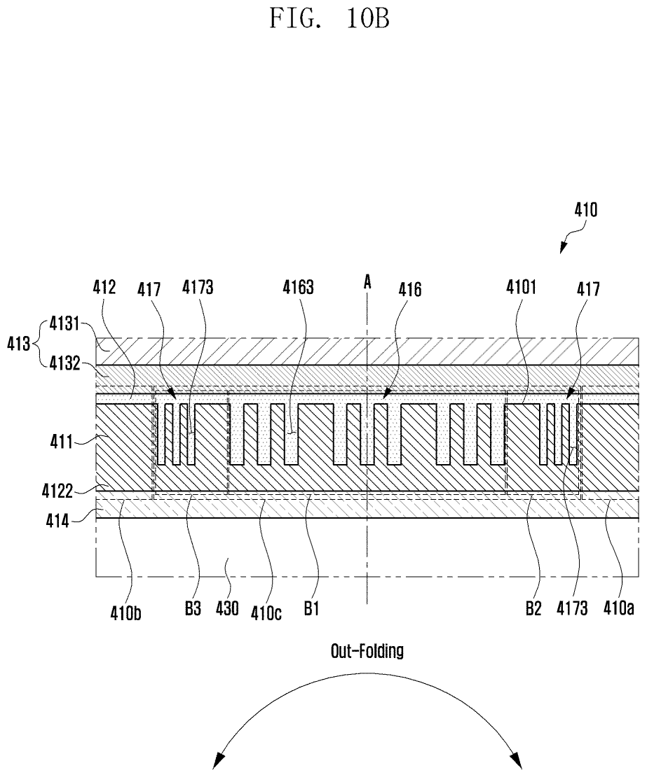

FIGS. 10A and 10B are partial cross-sectional views of a flexible display including a glass layer with a plurality of recesses according to various embodiments of the disclosure.

In describing the window layer 410 shown in FIGS. 10A and 10B, the same reference numerals are assigned to components substantially the same as those of the window layer 410 shown in FIG. 5C, and the detailed description thereof may be omitted.

With reference to FIG. 10A, the window layer 410 may have a plurality of recesses 4162 and 4172 formed to have a specified width and a specified depth in a direction from the second surface 4102 to the first surface 4101 of the glass layer 411. Through this structure, the window layer 410 may help the bending operation of the flexible display operating in an in-folding style.

According to various embodiments, the window layer 410 may include a filling member 412 for filling the plurality of recesses 4162 and 4172. According to an embodiment, in the third region 410c of the window layer 410, the plurality of recesses 4162 and 4172 may include a plurality of first recesses 4162 formed in a region of the glass layer 411 corresponding to the first sub-region B1, and a plurality of second recesses 4172 formed in a region of the glass layer 411 corresponding to the second sub-regions B2 and B3. According to an embodiment, the bendability of the first sub-region B1 may be set to be greater than the bendability of the second sub-regions B2 and B3, and the filling amount of the filling member 412 filling the plurality of first recesses 4162 corresponding to the first sub-region B1 may be greater than the filling amount of the filling member 412 filling the plurality of second recesses 4172 corresponding to the second sub-regions B2 and B3.

With reference to FIG. 10B, the window layer 410 may have a plurality of recesses 4163 and 4173 formed to have a specified width and a specified depth in a direction from the first surface 4101 to the second surface 4102 of the glass layer 411. Through this structure, the window layer 410 may help the bending operation of the flexible display operating in a folding-out style.

According to various embodiments, the window layer 410 may include a filling member 412 for filling the plurality of recesses 4163 and 4173. According to an embodiment, in the third region 410c of the window layer 410, the plurality of recesses 4163 and 4173 may include a plurality of first recesses 4163 formed in a region of the glass layer 411 corresponding to the first sub-region B1, and a plurality of second recesses 4173 formed in a region of the glass layer 411 corresponding to the second sub-regions B2 and B3. According to an embodiment, the bendability of the first sub-region B1 may be set to be greater than the bendability of the second sub-regions B2 and B3, and the filling amount of the filling member 412 filling the plurality of first recesses 4163 corresponding to the first sub-region B1 may be greater than the filling amount of the filling member 412 filling the plurality of second recesses 4173 corresponding to the second sub-regions B2 and B3.

According to various embodiments of the disclosure, because the glass layer 411 with a sufficient thickness is applied to the window layer 410, ensuring the rigidity of the flexible display 400 is possible. In addition, the plurality of openings 4161 and 4171 and/or the plurality of recesses 4162, 4163, 4172, and 4173, which are formed in the bendable third region (e.g., the third region 410c in FIG. 5A) of the glass layer 411 and are filled with the filling member 412, may improve the bendability of the flexible display 400.

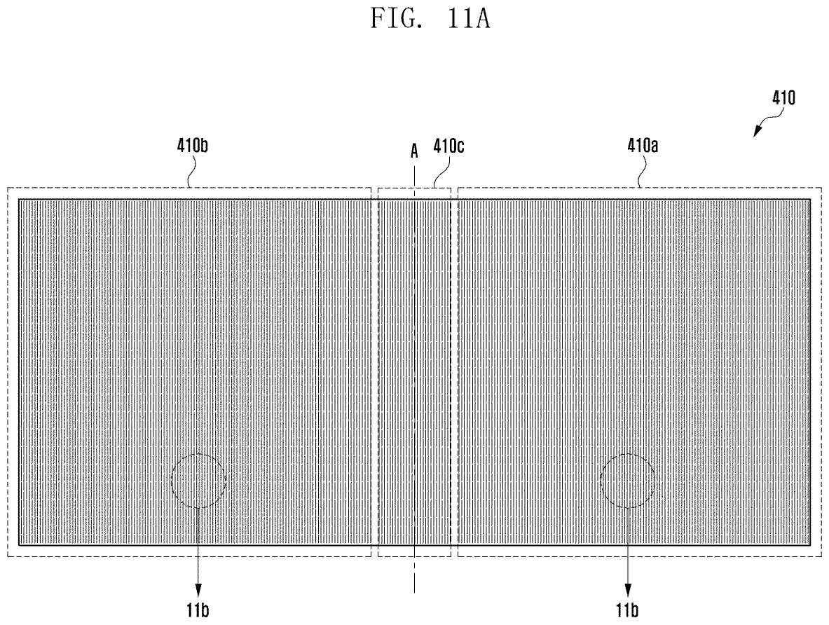

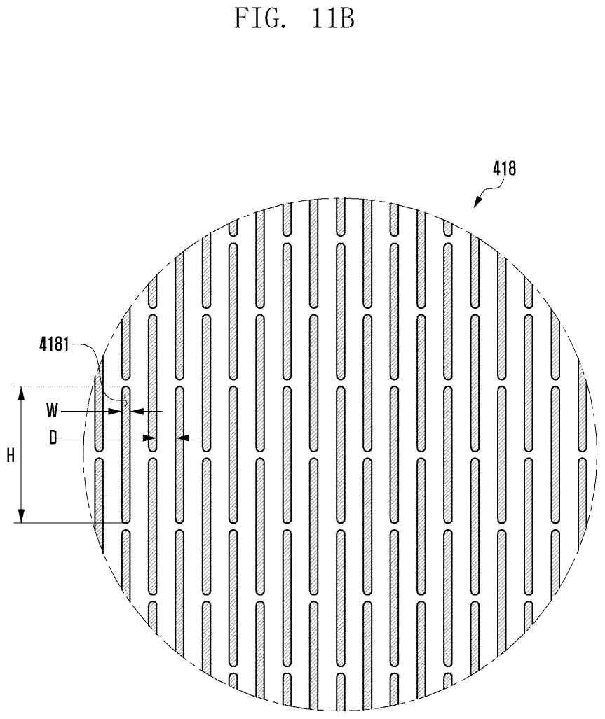

FIG. 11A is a plan view of a window layer according to various embodiments of the disclosure. FIG. 11B is an enlarged view illustrating a region 11b of FIG. 11A according to various embodiments of the disclosure.

With reference to FIGS. 11A and 11B, the window layer 410 may have a third pattern 418 including a plurality of third openings 4181 formed in the glass layer (e.g., the glass layer 411 in FIG. 5C) in the first and second regions 410a and 410b. In this case, the plurality of third openings 4181 may be filled with a filling member (e.g., the filling member 412 in FIG. 5C) like a plurality of first openings (e.g., the plurality of first openings 4161 in FIG. 5C) and a plurality of second openings (e.g., the plurality of second openings 4171 in FIG. 5C) arranged in the third region 410c, and a first planarization layer (e.g., the first planarization layer 4121 in FIG. 5C) and a second planarization layer (e.g., the second planarization layer 4122 in FIG. 5C) may be included.

According to various embodiments, each of the plurality of third openings 4181 may be formed in a slit structure that has a specified length H along the folding axis A, a specified width W smaller than the specified length H, and a specified interval D to each other. In some embodiments, the plurality of third openings may be formed in various shapes as described above. According to an embodiment, the plurality of third openings 4181 may be substantially identical in a shape and/or an arrangement structure with the plurality of first openings 4161 or the plurality of second openings 4171. In some embodiments, the plurality of third openings 4181 may be different in a shape and/or an arrangement structure from the plurality of first openings 4161 and the plurality of second openings 4171. According to an embodiment, through the plurality of third openings 4181 formed in regions of the glass layer 411 corresponding to the first and second regions 410a and 410b, the window layer 410 may help to reduce the weight of the flexible display 400.

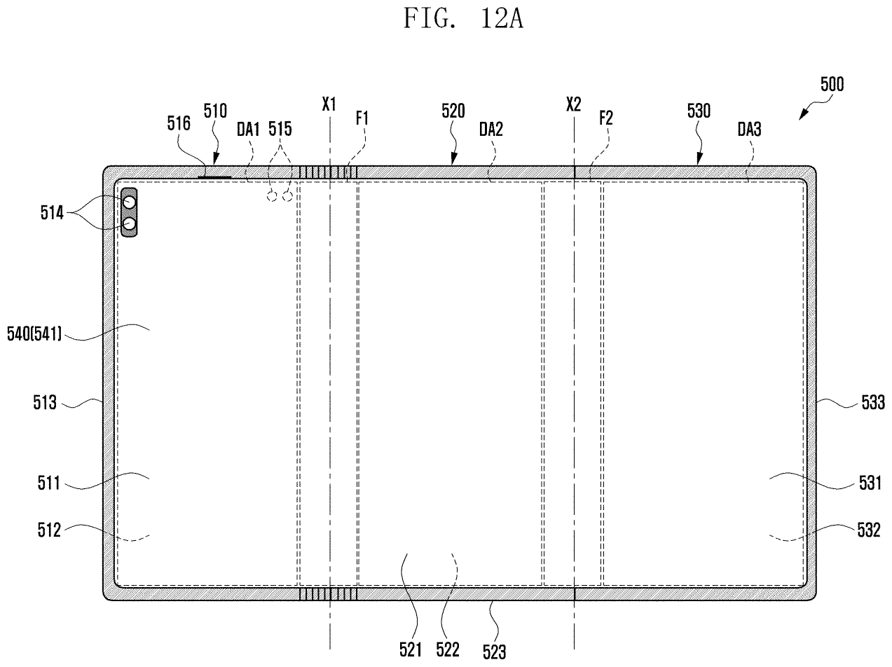

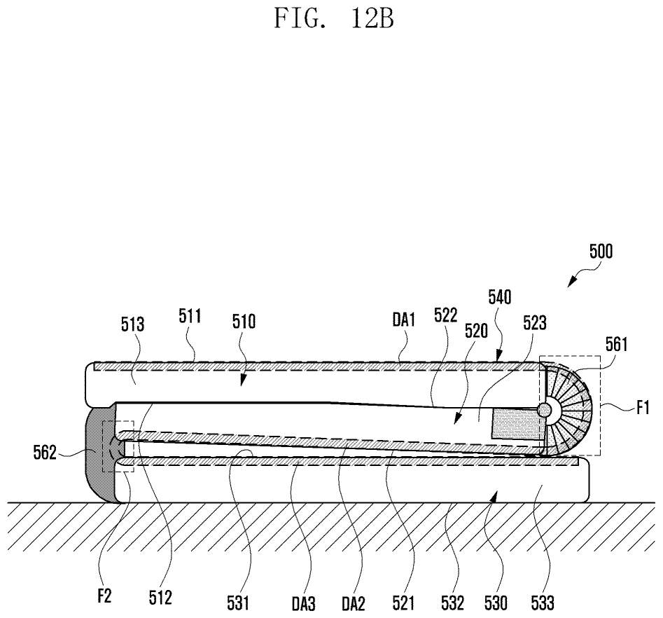

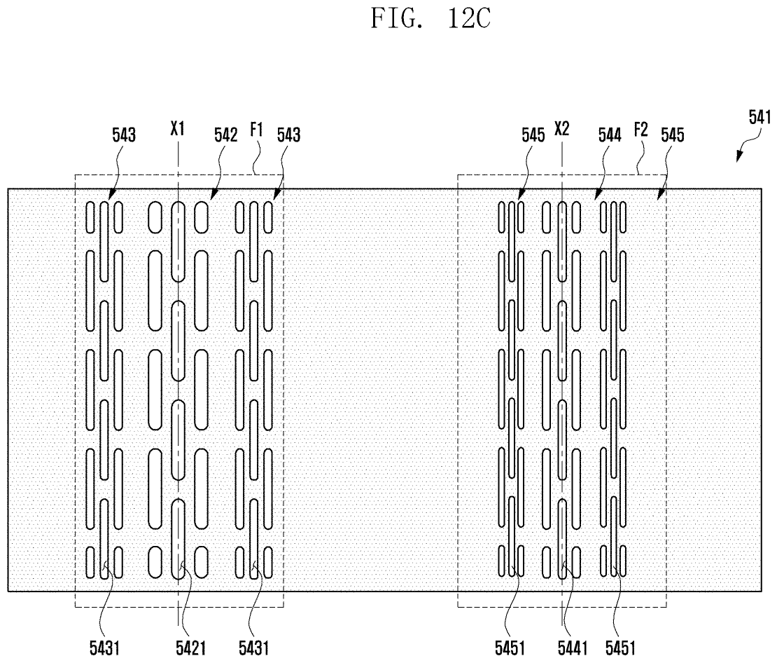

FIG. 12A is a view illustrating an unfolding state of an electronic device according to various embodiments of the disclosure. FIG. 12B is a view illustrating a folding state of an electronic device according to various embodiments of the disclosure.

With reference to FIGS. 12A and 12B, the electronic device 500 may include a first housing 510, a second housing 520, and a third housing 530, which are rotatably disposed with respect to each other. According to an embodiment, the electronic device 500 may include a flexible display 540 disposed to be supported by the first housing 510, the second housing 520, and the third housing 530. According to an embodiment, the first housing 510 and the second housing 520 may be rotatably connected to each other through a first hinge 561 based on a first folding axis X1. According to an embodiment, the second housing 520 and the third housing 530 may be rotatably connected to each other through a second hinge 562 based on a second folding axis X2. According to an embodiment, the first and second housings 510 and 520 may be operated in a first folding style (e.g., out-folding style) through the first hinge 561. For example, in a folding state, the first and second housings 510 and 520 may be disposed so that display areas corresponding to the respective housings 510 and 520 face opposite directions and thereby can be seen from the outside.

According to various embodiments, the second and third housings 520 and 530 may be operated in a second folding style (e.g., in-folding style) through the second hinge 562. For example, in a folding state, the second and third housings 520 and 530 may be disposed so that display areas corresponding to the respective housings 520 and 530 face each other. According to an embodiment, the electronic device 500 may be operated in a state where all of the first housing 510, the second housing 520, and the third housing 530 are fully unfolded. According to an embodiment, the electronic device 500 may be operated in a state where only the first and second housings 510 and 520 are folded. According to an embodiment, the electronic device 500 may be operated in a state where all of the first housing 510, the second housing 520, and the third housing 530 are fully folded. According to an embodiment, in the fully folded state, the display area corresponding to the first housing 510 may be disposed toward the outside of the electronic device 500 to be visible to a user. In this case, the camera module 514 and the sensor module 515 may be disposed in the first housing 510 to detect the external environment through the first display area. The sound output device 516 is also disposed towards the outside of the electronic device 500 in the fully folded state.

According to various embodiments, the first housing 510 may have a first surface 511, a second surface 512 facing in a direction opposite to the first surface 511, and a first side member 513 surrounding a space between the first and second surfaces 511 and 512. According to an embodiment, the second housing 520 may have a third surface 521, a fourth surface 522 facing in a direction opposite to the third surface 521, and a second side member 523 surrounding a space between the third and fourth surfaces 521 and 522. According to an embodiment, the third housing 530 may have a fifth surface 531, a sixth surface 532 facing in a direction opposite to the fifth surface 531, and a third side member 533 surrounding a space between the fifth and sixth surfaces 531 and 532. According to an embodiment, the flexible display 540 may be disposed to be supported by the first surface 511, the third surface 521, and the fifth surface 531.

According to various embodiments, the flexible display 540 may include a glass layer 541 (e.g., the glass layer 411 in FIG. 5C) that protects a display panel (e.g., the display panel 430 in FIG. 5C) and is stacked thereon to provide bendability. According to an embodiment, the glass layer 541 may have a first region DA1 corresponding to the first housing 510, a second region DA2 corresponding to the second housing 520, and a third region DA3 corresponding to the third housing 530. According to an embodiment, the glass layer 541 may also have a first folding region F1 corresponding to the first hinge 561 between the first region DA1 and the second region DA2, and a second folding region F2 corresponding to the second hinge 562 between the second region DA2 and the third region DA3. According to an embodiment, the first folding region F1 and the second folding region F2 may have a plurality of openings (e.g., a plurality of openings 5421, 5431, 5441, and 5451 in FIG. 12C) and a filling member (e.g., the filling member 412 in FIG. 5C) filled therein to provide different bendability for each region.

FIG. 12C is a partial plan view of a glass layer having regions corresponding to first and second folding regions according to various embodiments of the disclosure.

With reference to FIG. 12C, the glass layer 541 may include, in the first folding region F1, a first pattern 542 having a plurality of first openings 5421 arranged in a region containing the first folding axis X1, and a second pattern 543 having a plurality of second openings 5431 respectively arranged on left and right sides with the first pattern 542 interposed therebetween. According to an embodiment, the glass layer 541 may include, in the second folding region F2, a third pattern 544 having a plurality of third openings 5441 arranged in a region containing the second folding axis X2, and a fourth pattern 545 having a plurality of fourth openings 5451 respectively arranged on left and right sides with the third pattern 544 interposed therebetween.

According to various embodiments, in the first folding region F1 operating in the out-folding style, the bendability of the region where the plurality of first openings 5421 are formed may be set to be greater than the bendability of the region where the plurality of second openings 5431 are formed. Such a difference in bendability may be determined depending on the opening ratios based on shapes and/or arrangement densities of the plurality of first and second openings 5421 and 5431. In some embodiments, the plurality of openings 5421 and 5431 formed in the first folding region F1 may be replaced with the plurality of recesses 4163 and 4173 formed in the glass layer 541 as shown in FIG. 10B.

According to various embodiments, in the second folding region F2 operating in the in-folding style, the bendability of the region where the plurality of third openings 5441 are formed may be set to be greater than the bendability of the region where the plurality of fourth openings 5451 are formed. Such a difference in bendability may be determined depending on the opening ratios based on shapes and/or arrangement densities of the plurality of third and fourth openings 5441 and 5451. In some embodiments, the plurality of openings 5441 and 5451 formed in the second folding region F2 may be replaced with the plurality of recesses 4162 and 4172 formed in the glass layer 541 as shown in FIG. 10A.

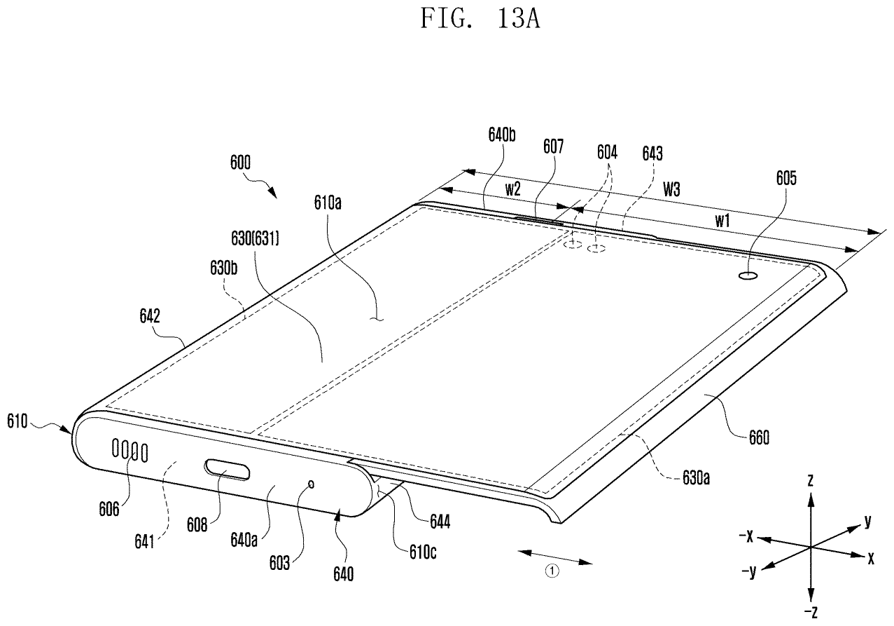

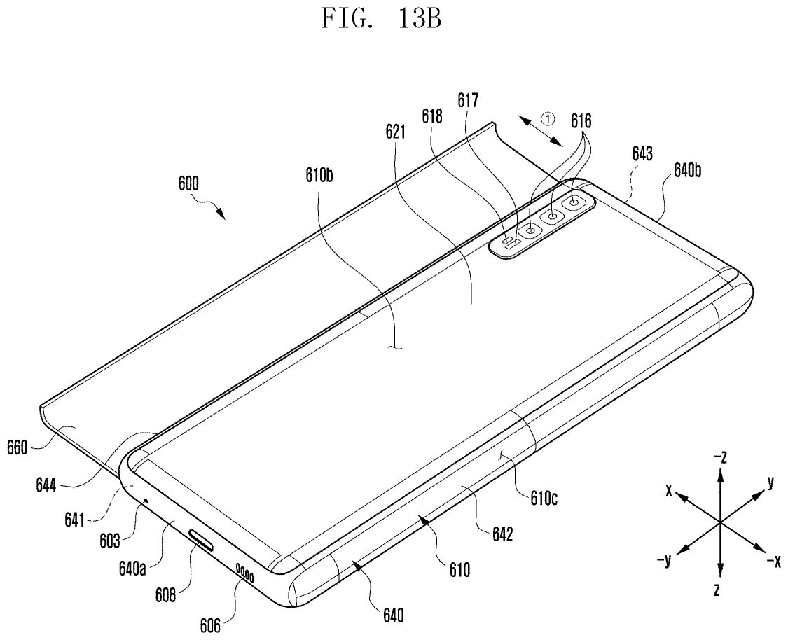

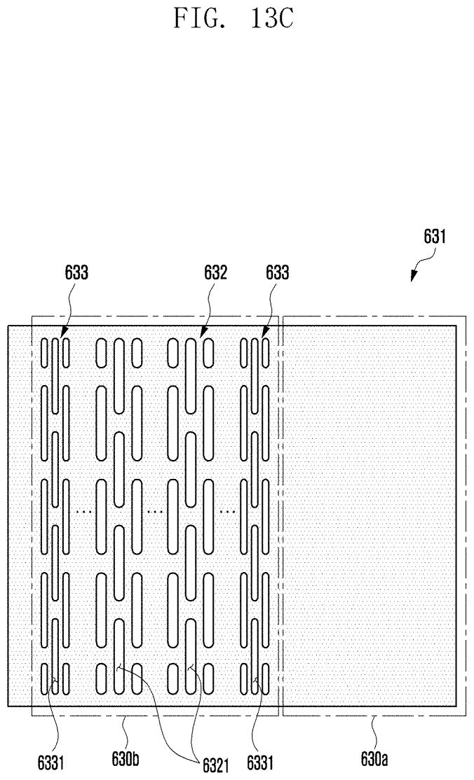

FIGS. 13A and 13B are views illustrating the front and rear of an electronic device according to various embodiments of the disclosure.

With reference to FIGS. 13A and 13B, the electronic device 600 may include a housing 610 (e.g., a first housing or a base housing) and a slide structure 660 (e.g., a second housing or a slide housing) combined movably at least in part with the housing 610 and supporting at least a portion of a flexible display 630. According to an embodiment, the slide structure 660 may include a bendable member (not shown) (e.g., a multi joint hinge or multi-bar assembly) coupled to one end and supporting at least a portion of the flexible display 630. For example, when the slide structure 660 performs a sliding operation on the housing 610, the bendable member may be at least partially introduced into the inner space of the housing 610 while supporting the flexible display 630. According to an embodiment, the electronic device 600 may include the housing 610 (e.g., a housing structure) that has a front surface 610a (e.g., a first surface) facing a first direction (e.g., the positive Z-axis direction), a rear surface 610b (e.g., a second surface) facing a second direction (e.g., the negative Z-axis direction) opposite to the first direction, and a lateral member 640 surrounding a space between the front and rear surfaces 610a and 610b and having a side surface 610c exposed at least in part to the outside. According to an embodiment, the rear surface 610b may be formed through a rear cover 621 combined with the housing 610. According to an embodiment, the rear cover 621 may be formed of a polymer, coated or colored glass, ceramic, metal (e.g., aluminum, stainless steel (STS), or magnesium), or any combination thereof. In some embodiments, the rear surface 621 may be formed integrally with the housing 610. According to an embodiment, at least a portion of the side surface 610c may be disposed to be exposed to the outside through the housing 610.

According to various embodiments, the lateral member 640 may have a first lateral surface 641 having a first length, a second lateral surface 642 extended from the first lateral surface 641 to have a second length greater than the first length in a direction perpendicular to the first lateral surface 641, a third lateral surface 643 extended from the second lateral surface 642 in parallel with the first lateral surface 641 and having the first length, and a fourth lateral surface 644 extended from the third lateral surface 643 in parallel with the second lateral surface 642 and having the second length. According to an embodiment, the slide structure 660 supports the flexible display 630 and may increase the display area of the flexible display 630 through a slide-out in a direction (e.g., the positive X-axis direction) from the second lateral surface 642 to the fourth lateral surface 644, or decrease the display area of the flexible display 630 through a slide-in in a direction (e.g., the negative X-axis direction) from the fourth lateral surface 644 to the second lateral surface 642. According to an embodiment, the electronic device 600 may include a first lateral cover 640a and a second lateral cover 640b for covering the first lateral surface 641 and the third lateral surface 643. According to an embodiment, the first and third lateral surfaces 641 and 643 may be disposed so as not to be exposed to the outside through the first and second lateral covers 640a and 640b.

According to various embodiments, the electronic device 600 may include the flexible display 630 disposed to be supported by the slide structure 660. According to an embodiment, the flexible display 630 may include a first portion 630a (e.g., a flat portion) supported by the slide structure 660, and a second portion 630b (e.g., a bendable portion) extended from the first portion 630a and supported at least in part by the bendable member. According to an embodiment, at least a part of the second portion 630b may be inserted into the inner space of the housing 610 in a slide-in state (e.g., a state that the slide structure 660 is introduced into the housing 610) of the electronic device 600 and disposed so as not to be exposed to the outside, and may be exposed to the outside in a slide-out state (e.g., a state that the slide structure 660 is drawn out from the housing 610) of the electronic device 600 so as to be extended from the first portion 630a while supported is at least in part provided by the bendable member. Therefore, the electronic device 600 may include a rollable type or slidable type electronic device in which the display area of the flexible display 630 is varied through the movement of the slide structure 660 from the housing 610.

According to various embodiments, the slide structure 660 may be combined to be movable in a sliding scheme of sliding-in or sliding-out at least in part into or from the housing 610. For example, the electronic device 600 may be configured to have a first width W1 from the second lateral surface 642 to the fourth lateral surface 644 in the slide-in state. According to an embodiment, in the slide-out state of the slide structure 660, the electronic device 600 may be operated to have a third width W3 greater than the first width W1 as at least a portion of the bendable member introduced in the housing 610 moves to the outside of the electronic device so as to have an additional second width W2. Therefore, depending on the sliding operation of the slide structure 660, the display area of the electronic device 600 may be changed in response to changing the width of the electronic device.

According to various embodiments, the electronic device 600 may include at least one of an input device 603, sound output devices 606 and 607, sensor modules 604 and 617, camera modules 605 and 616, a connector port 608, a key input device (not shown), or an indicator (not shown). In another embodiment, the electronic device 600 may omit at least one of the above-described components or further include other components.

According to various embodiments, the input device 603 may include a microphone. In some embodiments, the input device 603 may include a plurality of microphones disposed to detect the direction of a sound. The sound output devices 606 and 607 may include speakers. The sound output devices 606 and 607 may include an external speaker 606 and a call receiver 607. In another embodiment, the sound output devices 606 and 607 may include a speaker (e.g., a piezo speaker) that operates without a separate speaker hole.

According to various embodiments, the sensor modules 604 and 617 may generate an electrical signal or data value corresponding to an internal operating state of the electronic device 600 or an external environmental state. The sensor modules 604 and 617 may include, for example, a first sensor module 604 (e.g., a proximity sensor or an illuminance sensor) disposed on the front surface of the electronic device and/or a second sensor module 617 (e.g., an HRM sensor) disposed on the rear surface. According to an embodiment, the first sensor module 604 may be disposed under the flexible display 630 on the front surface 610a of the electronic device 600. According to an embodiment, the first sensor module 604 may further include at least one of a proximity sensor, an illuminance sensor, a time of flight (TOF) sensor, an ultrasonic sensor, a fingerprint recognition sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, or a humidity sensor.

According to various embodiments, the camera devices 605 and 616 may include a first camera device 605 disposed on the front surface 610a of the electronic device 600 and a second camera device 616 disposed on the rear surface 610b. According to an embodiment, the electronic device 600 may include a flash 618 positioned near the second camera device 616. According to an embodiment, the camera devices 605 and 616 may include one or more lenses, an image sensor, and/or an image signal processor. According to an embodiment, the first camera device 605 may be disposed under the flexible display 630 and configured to photograph a subject through a portion of an active region of the flexible display 630. According to an embodiment, the flash 618 may include, for example, a light emitting diode or a xenon lamp. In some embodiments, two or more lenses (wide angle and telephoto lenses) and image sensors may be disposed on one surface of the electronic device 600.

According to various embodiments, the electronic device 600 may include at least one antenna (not shown). According to an embodiment, the at least one antenna may wirelessly communicate with, for example, an external electronic device or wirelessly transmit/receive power required for charging. According to an embodiment, the antenna may include a legacy antenna, a mmWave antenna, a near field communication (NFC) antenna, a wireless charging antenna, and/or a magnetic secure transmission (MST) antenna.

According to various embodiments, the flexible display 630 may include a glass layer 631 stacked on a display panel (e.g., the display panel 430 in FIG. 5C). According to an embodiment, the glass layer 631 may include a plurality of openings (e.g., the plurality of openings 6321 and 6331 in FIG. 13C) formed in a region corresponding to the second portion 630b bendable at least in part during a sliding operation of the slide structure 660 in a specified direction (direction θ), and a filling member (e.g., the filling member 412 in FIG. 5C) of an elastic material filling the plurality of openings 6321 and 6331, thereby ensuring the rigidity and bendability of the flexible display 630.

FIG. 13C is a partial plan view of a glass layer having a region corresponding to a second portion according to various embodiments of the disclosure.

With reference to FIG. 13C, the glass layer 631 may have the plurality of openings 6321 and 6331 formed in a region corresponding to at least a part of the second portion 630b of the flexible display 630. According to an embodiment, the plurality of openings 6321 and 6331 may include a first pattern 632 of the plurality of first openings 6321 disposed in a region reciprocating a portion having the greatest curvature during a sliding operation, and a second pattern 633 of the plurality of second openings 6331 disposed on both left and right sides of the first pattern 632 with the plurality of first openings 6321 interposed therebetween. In this case, the glass layer 631 may be set such that the opening ratio in a region of the first pattern 632 is greater than the opening ratio in a region of the second pattern 633. This difference in the opening ratio may be determined depending on the shapes and/or arrangement densities of the plurality of first and second openings 6321 and 6331. In some embodiments, the opening ratio of the plurality of first openings 6321 and the opening ratio of the plurality of second openings 6331 may be set to be substantially equal to each other.

According to various embodiments, the glass layer having the plurality of openings with different bendability for each region in the bendable portion may also be applied to a unidirectional rollable electronic device in which the flexible display is extendable by a certain distance from one end of the housing, or a bidirectional rollable electronic device in which the flexible display is extendable in opposite directions from both ends of the housing.

According to various embodiments, an electronic device (e.g., the electronic device 100 in FIG. 1B) may include a first housing (e.g., the first housing 110 in FIG. 1B), a second housing (e.g., the second housing 120 in FIG. 1B) foldably connected to the first housing through a hinge (e.g., the hinge 140 in FIG. 1B) based on a folding axis (e.g., the folding axis A in FIG. 1B), and a flexible display (e.g., the flexible display 400 in FIG. 1B) including a first portion (e.g., the first portion 130a in FIG. 1B) corresponding to the first housing, a second portion (e.g., the second portion 130b in FIG. 1B) corresponding to the second housing, and a bendable third portion (e.g., the third portion 130c in FIG. 1B) connecting the first portion and the second portion and corresponding to the hinge. The flexible display may include a window layer (e.g., the window layer 410 in FIG. 5C) including a first region (e.g., the first region 410a in FIG. 5C) corresponding to the first portion, a second region (e.g., the second region 410b in FIG. 5C) corresponding to the second portion, and a third region (e.g., the third region 410c in FIG. 5C) corresponding to the third portion and constituted to be bendable, a display panel (e.g., the display panel 430 in FIG. 5C) disposed under the window layer, and a subsidiary material layer (e.g., at least one of the polymer layer 440, the metal sheet layer 450, the digitizer 460, or the reinforcing plate 470 in FIG. 4) disposed under the display panel. The window layer may include a glass layer (e.g., the glass layer 411 in FIG. 5C) that has a plurality of openings (e.g., the plurality of first openings 4161 and the plurality of second openings 4171 in FIG. 5C) formed in the third region and a filling member (e.g., the filling member 412 in FIG. 5C) having a specified refractive index and filling the plurality of first openings, and the plurality of openings may be formed to have different opening ratios depending on a curvature of each bent region of the glass layer during bending.

According to various embodiments, the refractive index of the filling member may be substantially equal to a refractive index of the glass layer.

According to various embodiments, the third region may include a first sub-region and second sub-regions disposed with the first sub-region interposed therebetween, and the plurality of openings may include a plurality of first openings arranged in the first sub-region and having a first opening ratio, and a plurality of second openings arranged in the second sub-regions and having a second opening ratio lower than the first opening ratio.

According to various embodiments, the glass layer may have a first surface facing an outside of the electronic device and a second surface facing the display panel, and the plurality of openings may be formed to pass through the second surface from the first surface.

According to various embodiments, at least one planarization layer stacked on the first surface and/or the second surface may be further included.

According to various embodiments, the at least one planarization layer may be formed of a material identical with the filling member.

According to various embodiments, at least one protective layer stacked on the first surface may be further included.

According to various embodiments, the at least one protective layer may include a first polymer layer stacked on the first surface.

According to various embodiments, the at least one protective layer may include an additional glass layer stacked on the first surface, and a first polymer layer stacked on the additional glass layer.

According to various embodiments, the additional glass layer may be disposed to have a thickness smaller than a thickness of the glass layer.

According to various embodiments, a second polymer layer disposed between the second surface and the display panel may be further included.

According to various embodiments, starting and ending edge portions of the plurality of openings may be tapered or curved.

According to various embodiments, an interval between the plurality of openings may be formed to be smaller than a radius of a contact area of an electronic pen in contact with the window layer.

According to various embodiments, a bendability of the third region may be determined through a shape and/or an arrangement structure of the plurality of openings.

According to various embodiments, a plurality of third openings formed in the glass layer corresponding to the first and second regions may be included, and the plurality of third openings may be filled with the filling member.

According to various embodiments, an opening ratio of the glass layer corresponding to the first and second regions may be substantially equal to or different from an opening ratio of the glass layer corresponding to the third region.

According to various embodiments, an electronic device may include at least one bendable housing (e.g., the first housing 110 and the second housing 120 in FIG. 1B), and a flexible display (e.g., the flexible display 400 in FIG. 1B) including a bending portion (e.g., the third portion 130c in FIG. 1B) that is bendable at least in part through a support of the at least one housing, and including a window layer (e.g., the window layer 410 in FIG. 5C), a display panel (e.g., the display panel 430 in FIG. 5C) disposed under the window layer, and a subsidiary material layer (e.g., at least one of the polymer layer 440, the metal sheet layer 450, the digitizer 460, or the reinforcing plate 470 in FIG. 4) disposed under the display panel, wherein the window layer includes a glass layer (e.g., the glass layer 411 in FIG. 5C) that has a plurality of openings (e.g., the plurality of first openings 4161 and the plurality of second openings 4171 in FIG. 5C) formed in a region corresponding to the bending region at specified intervals and a filling member (e.g., the filling member 412 in FIG. 5C) filling the plurality of openings, and wherein the plurality of openings are formed to have different opening ratios depending on a curvature of each bent region in the bending portion during bending.

According to various embodiments, a refractive index of the filling member may be substantially equal to a refractive index of the glass layer.

According to various embodiments, the glass layer may have a first surface facing an outside of the electronic device and a second surface facing the display panel, and the window layer may further include at least one protective layer stacked on the first surface, or an impact absorbent layer disposed between the second surface and the display panel.

According to various embodiments, the at least one protective layer may include an additional glass layer stacked on the first surface and having a thickness smaller than a thickness of the glass layer, and a polymer layer stacked on the additional glass layer.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a first housing;
a second housing foldably connected to the first housing through a hinge; and
a flexible display having a first portion corresponding to the first housing, a second portion corresponding to the second housing, and a bendable third portion connecting the first portion and the second portion, the flexible display including:
a window layer having a first region corresponding to the first portion, a second region corresponding to the second portion, and a third region corresponding to the bendable third portion and configured bend;
a display panel disposed under the window layer; and
a subsidiary material layer disposed under the display panel,
wherein the window layer includes:
a glass layer that has a plurality of openings formed in the third region, and
a filling member having a specified refractive index and filling the plurality of openings, and
wherein the plurality of openings are formed to have different opening ratios depending on a curvature of each bent region of the glass layer when the first and second housings and flexible display are in a folded state.

2. The electronic device of claim 1, wherein the refractive index of the filling member is substantially equal to a refractive index of the glass layer.

3. The electronic device of claim 1, wherein:
the third region includes a first sub-region and second sub-regions disposed with the first sub-region interposed between the second sub-regions, and
the plurality of openings include:
a plurality of first openings arranged in the first sub-region and having a first opening ratio, and
a plurality of second openings arranged in the second sub-regions and having a second opening ratio lower than the first opening ratio.

4. The electronic device of claim 1, wherein:
the glass layer has a first surface facing an outside of the electronic device and a second surface facing the display panel, and
the plurality of openings are formed to pass through the second surface from the first surface.

5. The electronic device of claim 4, further comprising:
at least one planarization layer stacked on the first surface or the second surface.

6. The electronic device of claim 5, wherein the at least one planarization layer is formed of a material that is identical with the filling member.

7. The electronic device of claim 4, further comprising:
at least one protective layer stacked on the first surface.

8. The electronic device of claim 7, wherein the at least one protective layer includes a first polymer layer stacked on the first surface.

9. The electronic device of claim 7, wherein the at least one protective layer includes:
an additional glass layer stacked on the first surface; and
a first polymer layer stacked on the additional glass layer.

10. The electronic device of claim 9, wherein the additional glass layer is formed to have a thickness smaller than a thickness of the glass layer.

11. The electronic device of claim 4, further comprising:
a second polymer layer disposed between the second surface and the display panel.

12. The electronic device of claim 1, wherein edge portions at both ends of the plurality of openings are tapered or curved.

13. The electronic device of claim 1, wherein an interval between the plurality of openings is formed to be less than a radius of a contact area of an electronic pen in contact with the window layer.

14. The electronic device of claim 1, wherein a bendability of the third region is determined through a shape or an arrangement structure of the plurality of openings.

15. The electronic device of claim 1, wherein:
a plurality of third openings formed in the glass layer corresponding to the first and second regions are included, and
the plurality of third openings are filled with the filling member.

16. The electronic device of claim 15, wherein an opening ratio of the glass layer corresponding to the first and second regions is different from an opening ratio of the glass layer corresponding to the third region.

17. An electronic device comprising:
at least one bendable housing; and
a flexible display including a bending portion that is bendable at least in part through a support of the at least one housing, the flexible display including:
a window layer;
a display panel disposed under the window layer; and
a subsidiary material layer disposed under the display panel,
wherein the window layer includes:
a glass layer that has a plurality of openings formed in a region corresponding to the bending portion at specified intervals, and
a filling member filling the plurality of openings, and
wherein the plurality of openings are formed to have different opening ratios depending on a curvature of each bent region in the bending portion during bending.

18. The electronic device of claim 17, wherein a refractive index of the filling member is substantially equal to a refractive index of the glass layer.

19. The electronic device of claim 17, wherein:
the glass layer has a first surface facing an outside of the electronic device and a second surface facing the display panel, and
the window layer further includes:
at least one protective layer stacked on the first surface; or
an impact absorbent layer disposed between the second surface and the display panel.

20. The electronic device of claim 19, wherein the at least one protective layer includes:
an additional glass layer stacked on the first surface and having a thickness smaller than a thickness of the glass layer; and
a polymer layer stacked on the additional glass layer.
